(19) United States
(12) Patent Application Publication
(10) Pub. No.: US 2026/0322840 A1
(43) Pub. Date: Oct. 15, 2026

(54) INTEGRATIONS BETWEEN A FORENSIC INVESTIGATION AND A CYBER SECURITY SYSTEM

(71) Applicant: Darktrace Holdings Limited, Cambridge (GB)

(72) Inventors: Timothy Bazalgette, Knebworth (GB); Jonathan Durston, Cambridge (GB); Patrick Osborne, Brighton (GB); Robin Clement, Cambridge (GB); John Boyer, Cambridge (GB); Connor Trimble, Cambridge (GB)

(21) Appl. No.: 19/575,081

(22) Filed: Mar. 23, 2026

Related U.S. Application Data
(60) Provisional application No. 63/775,808, filed on Mar. 21, 2025.

(51) Int. Cl. H04L 9/40

(52) U.S. Cl. CPC H04L 63/1425

(57) ABSTRACT

A forensic acquisition and investigation service can receive a trigger signal, including any of i) an alert, ii) a model breach, and iii) a cyber threat investigation, from one or more parts of a cyber security system. The service parses through information in the trigger signal to identify any components indicated in the trigger signal in order to launch a forensic acquisition investigation on the components indicated in the trigger signal, to store one or more snapshots of information captured during the forensic acquisition investigation from the components, and then to cooperate with a user interface to present the trigger signal of i) the alert, ii) the model breach, and/or iii) the cyber threat investigation on the user interface as well as the information captured from the one or more snapshots from the forensic acquisition investigation on the user interface.

### RELATED APPLICATION

This application claims priority under 35 USC 119 to U.S. provisional patent application No. 63/775,808, titled “CYBER SECURITY PROTECTION,” filed Mar. 21, 2025, which the disclosure of such is incorporated herein by reference in its entirety.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Cyber security and in an embodiment use of Artificial Intelligence in cyber security.

### BACKGROUND

Cybersecurity attacks have become a pervasive problem for enterprises as many computing devices and other resources have been subjected to attack and compromised. A “cyberattack” constitutes a threat to security of an enterprise (e.g., enterprise network, one or more computing devices connected to the enterprise network, or the like). A cyber threat from a cyberattack may involve malicious software, an insider attack, and other threat introduced into a computing device and/or the network. The cyber threats may further represent malicious or criminal activity, ranging from theft of credential to even a nation-state attack, where the source initiating or causing the security threat is commonly referred to as a “malicious” source.

Forensic investigation times generally take days to complete. This can cause a cloud security gap that organizations suffer damage before they can contain cloud incidents that would have benefited from a forensic investigation.

### SUMMARY

Methods, systems, and apparatus are disclosed for an Artificial Intelligence-based cyber security system. In an embodiment, a forensic acquisition and investigation service can receive a trigger signal, including any of i) an alert, ii) a model breach, and iii) a cyber threat investigation, from one or more parts of a cyber security system, to parse through information in the trigger signal to identify any components indicated in the trigger signal, to launch a forensic acquisition investigation on the components indicated in the trigger signal, to store one or more snapshots of information captured during the forensic acquisition investigation from the components, and then to cooperate with a user interface to present the trigger signal of i) the alert, ii) the model breach, and/or iii) the cyber threat investigation on the user interface as well as the information captured from the one or more snapshots from the forensic acquisition investigation on the user interface.

These and other features of the design provided herein can be better understood with reference to the drawings, description, and claims, all of which form the disclosure of this patent application.

### DRAWINGS

The drawings refer to some embodiments of the design provided herein in which:

FIG. 1 illustrates a block diagram of an embodiment of the forensic acquisition and investigation service that receives a trigger signal from one or more parts of a cyber security system to parse through information in the trigger signal to identify any components indicated in the trigger signal to launch a forensic acquisition investigation on the components indicated in the trigger signal.

FIG. 2 illustrates a diagram of an embodiment of the forensic acquisition and investigation service that receives the trigger signal, including any of i) the alert, ii) the model breach, and/or iii) the cyber threat investigation, from one or more parts of the cyber security system, where one or more parts of the cyber security system include a cyber-security restoration engine, a cybersecurity appliance, a cyber threat analyst module, and a cyber-attack simulator.

FIG. 3 illustrates a graph of an embodiment of an example chain of unusual behavior for, in this example, the email activities and IT network activities deviating from a normal pattern of life in connection with the rest of the system/network under analysis.

FIG. 4 illustrates a block diagram of an embodiment of the AI-based cyber security appliance with example components that protects a system, including but not limited to a network/domain, from cyber threats.

FIG. 5 illustrates a diagram of an embodiment of i) the cyber security appliance using Artificial Intelligence algorithms trained to perform a first machine-learned task of detecting the cyber threat, ii) an autonomous response module using Artificial Intelligence algorithms trained to perform a second machine-learned task of taking one or more mitigation actions to mitigate the cyber threat, iii) a cyber-security restoration engine using Artificial Intelligence algorithms trained to perform a third machine-learned task of remediating the system being protected back to a trusted operational state, and iv) a cyber-attack simulator using Artificial Intelligence algorithms trained to perform a fourth machine-learned task of Artificial Intelligence-based simulations of cyberattacks to assist in determining 1) how a simulated cyberattack might occur in the system being protected, and 2) how to use the simulated cyberattack information to preempt possible escalations of an ongoing actual cyberattack, in order for these four Artificial Intelligence-based engines to work together.

FIG. 6 illustrates a diagram of an embodiment of the cyber-attack simulator and its Artificial Intelligence-based simulations constructing an example graph of nodes in an example network and simulating how the cyberattack path might likely progress in the future tailored with an innate understanding of a normal behavior of the nodes in the system being protected and a current operational state of each node in the graph of the protected system during simulations of cyberattacks.

FIG. 7 illustrates a diagram of an embodiment of the cyber-attack simulator and/or the cyber-attack restoration engine assigning scores for a portion of the graph of nodes of the system being protected (e.g. a network) including i) the physical devices, accounts, etc. in the system, as well as ii) connections and attack pathways through the network.

FIG. 8 illustrates a block diagram of an embodiment of the AI-based cyber security appliance with the forensic acquisition and investigation service and other Artificial Intelligence-based engines plugging in to protect a system.

FIG. 9 illustrates a block diagram of an embodiment of one or more computing devices that can be a part of the Artificial Intelligence-based cyber security system including the multiple Artificial Intelligence-based engines and the forensic acquisition and investigation service discussed herein.

While the design is subject to various modifications, equivalents, and alternative forms, specific embodiments thereof have been shown by way of example in the drawings and will now be described in detail. It should be understood that the design is not limited to the particular embodiments disclosed, but-on the contrary-the intention is to cover all modifications, equivalents, and alternative forms using the specific embodiments.

### DESCRIPTION

In the following description, numerous specific details are set forth, such as examples of specific data signals, named components, number of servers in a system, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as a first server, can be made. However, the specific numeric reference should not be interpreted as a literal sequential order but rather interpreted that the first server is different than a second server. Thus, the specific details set forth are merely exemplary. Also, the features implemented in one embodiment may be implemented in another embodiment where logically possible. The specific details can be varied from and still be contemplated to be within the spirit and scope of the present design.

In general, a forensic acquisition and investigation service can receive a trigger signal, including any of i) an alert, ii) a model breach, and iii) a cyber threat investigation, from one or more parts of a cyber security system. The cyber security system can include a cyber-security restoration engine, a cybersecurity appliance configured to detect a presence of a cyber threat, a cyber threat analyst module configured to perform the cyber threat investigation, and a cyber-attack simulator, and endpoint agents on an endpoint device. The forensic acquisition and investigation service parses through information in the trigger signal to identify any components indicated in the trigger signal in order to launch a forensic acquisition investigation on the components indicated in the trigger signal. The forensic acquisition and investigation service can then store one or more snapshots of information captured during the forensic acquisition investigation from the components. The forensic acquisition and investigation service can also cooperate with a user interface to present the trigger signal of i) the alert, ii) the model breach, and/or iii) the cyber threat investigation on the user interface as well as the information captured from the one or more snapshots from the forensic acquisition investigation on the user interface.

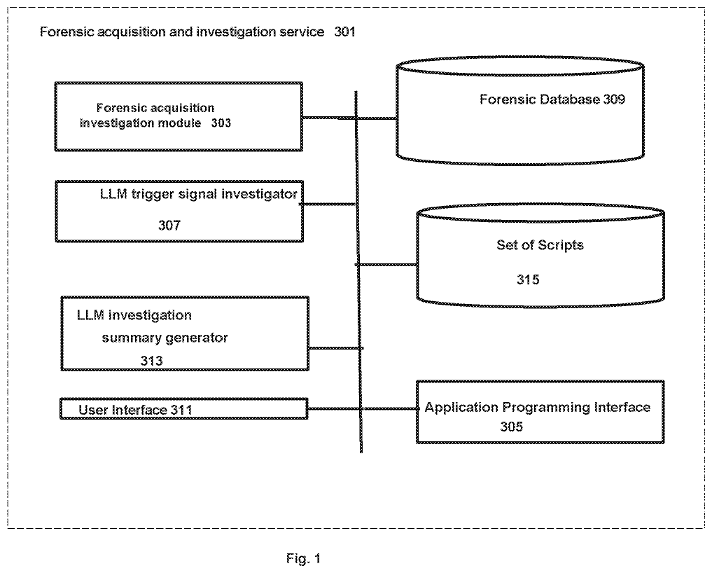

FIG. 1 illustrates a block diagram of an embodiment of the forensic acquisition and investigation service that receives a trigger signal from one or more parts of a cyber security system to parse through information in the trigger signal to identify any components indicated in the trigger signal to launch a forensic acquisition investigation on the components indicated in the trigger signal.

The forensic acquisition and investigation service 301 (e.g., Cado security forensics service) receives a trigger signal, through the application programming interface 301, including any of i) an alert, ii) a model breach, and iii) a cyber threat investigation, from one or more parts of a cyber security system, and uses the LLM based trigger signal investigator 307 to parse through information in the trigger signal to identify any components being protected by the cyber security system indicated in the trigger signal. The forensic acquisition investigation module 303 can evaluate the components involved with the trigger signal and then select from a set of scripts from the scripts database 315 to launch a forensic acquisition investigation on that corresponding component. The forensic acquisition investigation module 303 can launch a forensic acquisition investigation on all of the components indicated in the trigger signal. A forensic database 309 can then store one or more snapshots of information captured during the forensic acquisition investigation from the components, and then to cooperate with a user interface to present the trigger signal of i) the alert, ii) the model breach, and/or iii) the cyber threat investigation on the user interface as well as the information captured from one or more snapshots from the forensic acquisition investigation on the user interface.

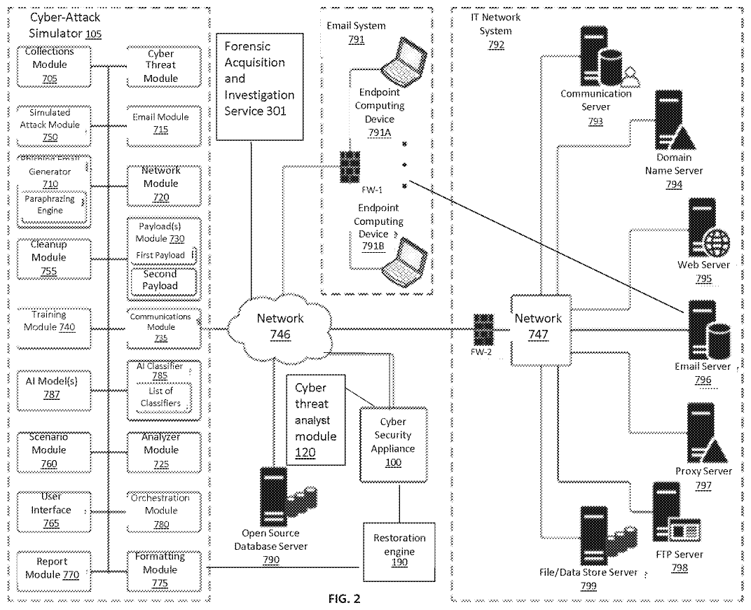

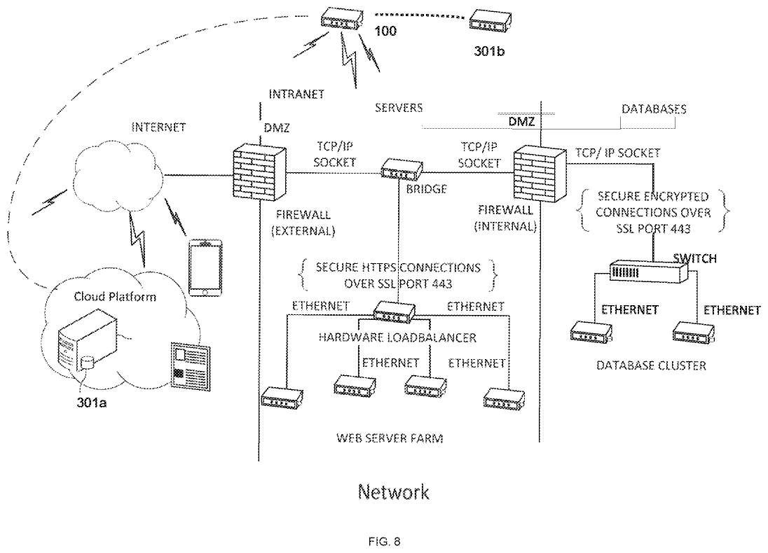

The forensic acquisition and investigation service 301 can be set up locally within each network on a plug in appliance managed by the organization being protected (see FIG. 8) and/or be set up on a cloud security platform and accessed as a cloud based SaaS service hosted on the cloud security platform managed by a security service, such as Darktrace (see FIGS. 2 and 8).

The forensic acquisition and investigation service 301 gives the capacity to receive an alert and/or cyber threat incident report to trigger a forensic-level investigation automatically for a number of contextual information-gathering purposes, such as the confirmation of potential vulnerability exploits, mitigating potential misconfigurations present on cloud devices, and manually for the purposes of manual threat hunting from a cloud interface.

The forensic acquisition and investigation service 301 is configured 1) to use the application programming interface 305 and the forensic acquisition investigation module 303 to select an appropriate script from a set of scripts to conduct the forensic acquisition investigation on the components, 2) to use the application programming interface 305 to receive a forensic artifact of a snapshot of at least an operational state and disk data of the components from the forensic acquisition investigation from a script, and 3) then the forensic database 309 to store information captured from the snapshot from the forensic acquisition investigation in the forensic database 309 that maintains a full chain of custody for forensic acquisition investigations.

A user interface, such as the user interface 311 of the forensic acquisition and investigation service 301 and/or a user interface associated with a part of the cyber security system, such as user interface 130 of the cyber security appliance 100 and user interface 765 of the cyber attack simulator 105, is scripted with various buttons/icon, graphs, and menus to display the information associated with the alert, model breach, and/or cyber threat investigation, an interactive element to trigger the forensic investigation, as well as a section to display all of the forensic information captured from each of the components (e.g., physical devices and virtual machines) associated with this alert/cyber threat investigation on a display screen to provide a composite understanding of an incident from a start. As discussed, the user interface 311 may be presented by the forensic acquisition and investigation service 301.

However, each of the parts of the cyber security system, do have their own user interface, which can display the forensic information from the forensic acquisition and investigation service 301 as well as launch a forensic acquisition investigation. The user interface and the application programming interface 305 of the forensic acquisition and investigation service 301 cooperate with the user interface of each of the parts of the cyber security system to display the same information from the forensic investigation on that user interface as well.

The forensic acquisition investigation is scripted with the set of scripts to take one or more snapshots in time. Each snapshot captures, for example, a component's configuration settings, operational state, disk data, and ephemeral process data of that component at a point in time. Thus, it is useful to do the forensic acquisition investigation when the initial events occur, when an incident happens, so the user knows what the state of the component was when the breach occurred, which most likely will be different later on during a cyber attack and/or after the cyber attack. The forensic acquisition investigation is able to take one or more snapshots of the configuration settings, operational state, disk data, and ephemeral process data of that component in a time period when launched, hopefully, before the cyber attacker might change the state of something or corrupt the data when the cyber attack proceeds further.

In an embodiment, the forensic acquisition and investigation service 301 can use one or more scripts, such as a security host binary executable application, stored in a scripts database 315 to investigate and acquire the information, such as configuration settings, operational state, disk data, and ephemeral process data, from the component being investigated at a point in time from a potentially compromised target device/component/container in a manner that maintains a full chain of custody for forensic investigations. The forensic acquisition investigation module 303 of the forensic acquisition and investigation service 301 uses the set of scripts from the scripts database 315 to launch the investigation to take one or more snapshots in time of the information including any of operational state information, configuration settings, disk data, and ephemeral process data, on the component being investigated in a manner with timestamps that maintains a full chain of custody for the forensic acquisition investigation on all of the components involved in the trigger signal.

In an example, the script to conduct the forensic acquisition investigation, such as the security host binary executable application, conducts the electronic and digital forensic investigation to access information from a component being investigated, such as a physical component and/or a target container. The security host binary executable application can then copy forensic data, such as a full disk image or specific container level data/information, from that target component (e.g., in the cloud a container in a Kubernetes or similar containerized environment). In an example, a script performing a forensic acquisition investigation on a laptop performs a full disk capture.

The security host binary executable application can acquire the information from the potentially compromised component in a manner that maintains a full chain of custody for forensic investigations. In another example, the script can capture a disk image of the data and the state of a component under analysis, including a log that captures information, such as which hosts accessed the target device/component/container, and other captured metadata, and then adds a time stamp to verify the veracity of the captured information. The example component being investigated can be in the IT network, email network, or cloud network (see for example FIG. 2). The security host binary executable application can gather as much data as possible (e.g., a large set of data including binary files as well as logs for the container and its virtual system) at a snapshot in time. The security host binary executable application gathers an in depth level of data, for later analysis, combined with often occasional data snapshot updates. A timeline of events with timestamps on the collected data can be created. The security host binary executable application can also generate a hash of the acquired data and store that hash. The security host binary executable application can compress the information collected from the potentially compromised component and then the compressed information is uploaded to, for example, cloud storage. The cloud storage can perform a cryptographic hash of the copied disk to create a chain of custody that ensures the disk image is a true copy of the original disk. The security host binary executable application then forensically packages the collected information and uploads that information to the forensic database 309 via the API 305. The forensic acquisition and investigation service 301 provides a truly automated cloud forensics solution.

Thus, an example security host binary executable application is scripted to be able to run in, for example, a Kubernetes container, under analysis. The script then collects information from, for example, the Kubernetes container including forensic artifacts and other information, and vSensors monitoring the virtual machine, and then uploads the collected files and other information back to cloud storage, which is then forwarded to an application programming interface 305 and forensic database 309 in the forensic acquisition and investigation service 301 for processing. Another example version of the security host binary executable application is scripted to be able to run on an operating system of the component/device, under analysis. This example security host binary executable application is scripted to be able to run on, for example, a specific operating system of the component/device, under analysis, to collect information from, for example, the operating system and any endpoint agent running on that component. The security host binary executable application copies data and metadata associated with the target device/component/container and forwards that information to cloud storage, and then the forensic acquisition investigation module 303 obtains that copy of the information and performs multiple kinds of analysis on that information. The security host binary executable application gathers all sorts of data, so that could be system logs, file system data, saved files, process data, etc. In an embodiment, the forensic acquisition and investigation service 301 can cooperate with an endpoint agent resident on a device to run its own data and state acquisition scripts and then format them into the forensic format to acquire the data from the potentially compromised target device/component in a manner that maintains a full chain of custody for forensic investigations. The forensic acquisition investigation module 303 can cooperate with third party services and their application programming interface 305 to acquire logs or other information that the third party service has on the potentially compromised device/component, etc. The forensic acquisition investigation module 303 creates the forensic unmodifiable version of the snapshot at that point in time, which includes what is the state of the component/device as well as all timestamped and verified data. The forensic acquisition and investigation service 301 then stores the snapshots and other information in a forensic database 309 as an unmodifiable version (e.g., read only version) of the snapshot at that point in time, which includes what is the state of the component/device, all timestamped and verified data to maintain the chain of custody. The alarms/alerts also include time stamped information on when they were generated.

The forensic acquisition investigation module 303 maintains a list of components and a corresponding set of scripts on how to access that component (including physical assets and virtual assets) and then i) copy data and state information and ii) if they exists obtain logs and other third party data for that particular component, aggregating that information, then further aggregating the information for that component to be married up to the alerts, model breaches, cyber threat investigation from the cybersecurity system that automatically triggered the forensic investigation, along with what user manually clicked the button on the user interface to launch the forensic investigation.

The scripts database 315 contains one or more scripts to forensically capture and collect host-level data, including disks, memory, logs, and artifacts the moment, for example, an alert is raised across on-premises, AWS, Azure, GCP and SaaS environments. The scripts forensically capture ephemeral data to preserve evidence from short-lived workloads, including AWS ECS, Kubernetes, and distro-less or no-shell containers, retaining critical data so that it can be investigated. After the information is captured, the script can then use compression algorithms, such as Zstandard (Zstd), Brotli, Gzip, Snappy, and LZ4, and hashing to transfer those large amounts of data across the internet/network back into the forensic acquisition and investigation service 301. The forensic acquisition and investigation service 301 can forensically capture state data and process data with a script that runs a dissolvable agent.

The script can first capture the information with a time stamp. The script can look for additional timing information. The script can automate the investigation by putting collected evidence into a complete timeline. The script can automatically reconstruct cyber attacker behavior into unified timelines, distilling massive volumes of events into the most significant insights to provide rapid clarity and root cause in minutes without manual correlation.

The forensic acquisition investigation runs through its scripts to automatically capture information from diverse sources directly from the potentially compromised component, its associated components, a third-party service providing that component, etc., either 1) automatically or 2) manually with one-click action, to launch the investigation from a user in the security team. The forensic acquisition investigation collects forensic-level evidence instantly, even in fast-moving cloud environments, and transforms investigative dead ends into actionable intelligence.

The forensic acquisition and investigation service 301 forensically captures information from components (e.g., physical devices and virtual machines) being protected by the AI-powered cybersecurity system as evidence that is automatically gathered by a script, through the acquisition of forensic artifacts, triggered automatically or manually, at a point in time, in order to confirm suspicions. The large language model (LLM) based investigation summary generator 313 can perform an analysis of those forensic artifacts captured by one or more snapshots in time to provide a written summary of what the LLM believes is happening along with the information captured in the snapshot and the alert and/or cyber threat incident triggering the forensic-level investigation. The forensic database 309 can cooperate with the user interface to present information onto the threat visualizer user interface.

The forensic acquisition investigation module 303 of the forensic acquisition and investigation service 301 can also send a signal to invoke the endpoint agent on an endpoint device (e.g., laptop) to capture operational state data, configuration settings, and process data on that endpoint computing device with time stamps at the point in time and then send that data where the forensic acquisition investigation module 303 forensically formats that information to create a forensic artifact to be saved in the forensic database 309.

The user interface has an interactive element (e.g., button/icon) that is scripted to allow a user to highlight and select any component in an architecture being protected by the cyber security system that is displayed on the user interface. After selecting the displayed component the user can then activate (e.g., click on) an investigate button to manually launch the forensic acquisition investigation on the selected component (including a physical asset and a virtual asset) as well as another section (e.g., tab/link) to review the trigger signal of i) the alert, ii) the model breach, and/or iii) the cyber threat investigation on the user interface along with the information captured from one or more snapshots from the forensic acquisition investigation on the user interface.

The user interface presents the component (including a physical asset and a virtual asset) being protected by one or more parts of the AI-powered cybersecurity system along with a review of the forensic artifact of the snapshot of state, settings, and data from the forensic acquisition investigation on that component. The user interface has a tab scripted to pull in additional information on any human or Artificial Intelligence based analyst review of this incident, and another tab to see a history of this component, including any previous investigations. Note, an additional button/icon exists to view all of the forensic investigations launched within a set window of time.

The forensic acquisition investigation can occur on a mix of different components (including physical assets and virtual assets) types. On each different component presented on the user interface, the user is able to trigger the forensic acquisition investigation 1) manually or 2) automatically based on thresholds, potentially set by the user. The user interface can feed back the results of the forensic acquisition investigation on a display screen to the user to provide a composite understanding of an incident from the start. The displayed information on the incident can span from seeing an unusual thing indicated by an alert, model breach, or unusual combination of events in a cyber threat investigation, and then the combined file system, alarms, alerts, and context (e.g., this component was seen in this incident, along with other components derived from the forensic acquisition investigation) to provide a wider context of why it's useful to investigate all of these particular components. The user interface breaks down the display of that information back clearly and concisely to the user in both a per incident/event or a per device basis.

Next, the forensic acquisition and investigation service 301 allows various types of assets, such as cloud assets, IT and email network components, etc., to be investigated from a number of places (the user interface of each part of the cyber security system as well as from the user interface of the forensic acquisition and investigation service 301). For example, the user interface is scripted to allow the user from the ‘device search’ to search for components to be presented in the main threat visualizer display and control console. The user interface, for example, from the cloud asset page from the cyber security appliance, allows the user to search directly for a resource/component that the user cares about to see its history and snapshots of information captured from the current forensic acquisition investigation as well as individual containers running as well as all other containers running the same particular task. The user interface is scripted to allow the user from the ‘Cloud assets search’ inside the CLOUD UI presented by the cyber security appliance. The user interface is scripted to allow the user from the ‘Architectures view’ to present the components display in their architecture, which can then be selected to initiate a forensic acquisition investigation.

The forensic acquisition and investigation service 301 tracks the progress of these investigations and, once complete, displays the results of the forensic acquisition investigation on the user interface, including the investigation summary and any evidence that has been captured (e.g., configuration settings, operational state, disk data, and ephemeral process data of that component at a point in time) during the forensic acquisition investigation.

The forensic acquisition and investigation service 301 supports cloud components, including, for example: EC2 instances—Elastic compute cloud AWS web services; Lambda functions—AWS code with managing servers; ECS containers—Elastic Cloud Containers from any provider; evidence inside an S3 bucket; Azure virtual machines; and Azure virtual machine disks.

The forensic acquisition and investigation service 301 can perform cloud-native, automated digital forensics and incident response activities such as forensic investigations that help security teams quickly detect, investigate, and respond to threats in hybrid and multi-cloud environments. The forensic acquisition and investigation service 301 and the cyber security system are designed to operate natively within cloud environments (AWS, Azure, GCP) and automate data acquisition, processing, and analysis. The cyber security system cooperating with the forensic acquisition and investigation service 301 can capture and preserve forensic data from various sources, including cloud resources, containers, SaaS applications, and endpoint devices, ensuring evidence is available for investigation. The cyber security system uses AI-powered analytics with machine learning to analyze data, identify malicious activity, and provide actionable insights to human security teams. The cyber security system with the forensic acquisition and investigation service 301 supports investigations across multiple cloud platforms, enabling security teams to respond to incidents regardless of where they occur. The cyber security system with the forensic acquisition and investigation service 301 allows for forensic investigation to also collect SaaS logs from platforms like Microsoft 365, Microsoft Entra ID, and Google Workspace, enabling faster triage of incidents like Business Email Compromise (BEC). The cyber security system with the Forensic acquisition and investigation service 301 automates the acquisition of endpoint resources to gain immediate event insights and facilitate quick escalation. The forensic acquisition and investigation service 301 supports investigations in container environments, including EKS, AKS, GKE, and Kubernetes. The forensic acquisition and investigation service 301 ensures that evidence residing in ephemeral environments is immediately captured and preserved before it disappears. By automating data collection and analysis, the cyber security system with the forensic acquisition and investigation service 301 reduces the time it takes for security teams to investigate incidents and respond to threats. The forensic acquisition and investigation service 301 provides automation capabilities to help security teams get to the root cause and scope of malicious activity faster, drastically reducing response times. The forensic acquisition and investigation service 301 integrates through application programming interface 305s, feedback loops, and links with one or more parts of the cyber security system, such as the cyber security appliance 100.

The forensic acquisition and investigation service 301 integration with the parts of the cyber security system allows the trigger signals of alerts, model breaches, cyber threat investigations, etc., from parts of the AI cyber security system to be sent to the forensic acquisition and investigation service 301 as soon as they occur to automatically trigger a forensic acquisition investigation. Note, other scenarios are implemented to manually trigger a forensic acquisition investigation. The forensic acquisition and investigation service 301 can use a trained large language model (LLM) in the LLM trigger signal investigator 307 to parse through the data from the model alerts and cyber threat incidents/investigations (e.g., cyber threat incidents/investigations produced from the cyber threat analyst module 120 (e.g. AI analyst)), extracting any components from the model alerts and cyber threat investigations, and then will launch a forensic investigation on all of the components associated that contains all the components (e.g., devices and virtual machines) in the alert/incident, and then will post the model breaches, alerts and/or cyber threat investigation on the user interface as well as the information captured from one or more snapshots from the forensic investigation.

The user interface is scripted to also allow users to be able to tune parameters that determine what types and levels of alerts, model breaches, and cyber threat incidents will be automatically sent to an application programming interface 305 of the forensic acquisition and investigation service 301 to trigger the forensic acquisition investigation to ensure that alerts and incidents over a certain threshold are automatically investigated forensically.

The parts of the cybersecurity system generate the alert, model breach, and/or cyber threat incidents with a high confidence reason (exceeded some threshold or preset condition) to have detected something of interest, some form of anomaly, without there being a requirement that it is kind of a specific known cyber threat but still invokes a forensic acquisition investigation of components involved with the alert or incident from the AI cybersecurity system. An advantage comes from the fact that the parts of the cybersecurity system have a high confidence reason to have detected something of interest, some form of anomaly, without there being a requirement that this unusual alert, model breach, etc., is currently known to be associated with a specific known cyber threat. So, for example, an unusual access occurs, or an unusual configuration on a device or a cloud entity, is detected. The forensic acquisition and investigation service 301 integrates with the parts of the cyber security system to trigger a full automated anomaly detection forensic capture pipeline, which allows the service to save off forensic artifacts, just in case anything changes. The forensic acquisition and investigation service 301 provides an all-incident assistance to the end user, because all of this is realistically done at machine speed. An AI model from any part of the cyber security system can generate an alert or model breach with a high confidence that something is definitely unusual and should be investigated. Also, a series of low confidence possibly related unusual events or misconfigurations can be detected in a cyber threat investigation conducted by the cyber threat analyst module 120 (e.g., AI analyst), which discovers that, for example, there is some link between the events and the unusual behavior analyzed, which then can also automatically invoke sending the trigger signal to launch a forensic acquisition investigation. This alert or series of alerts can happen at any time of the day—even off hours. The security team comes in on a next work shift and they have everything they need to investigate this incident, which was captured at a point in time when the system detected the unusual event. All of that is not predicated on the discovery of a specific known threat; but rather, automatically when simply a high confidence alert and/or model breach indicates that something is definitely unusual.

This same forensic acquisition investigation can be manually triggered by the user. For example, the cyber security appliance 100 allows a user to view a contextualized cloud-based cybersecurity view on its user interface. The user can see individual assets within the context of their wider interconnected systems and manually launch the forensic acquisition investigation on any of the displayed components to acquire the snap shots of forensic artifacts of the configuration and operational states of those cloud components.

Next, there are lots of different components that can have these forensic acquisition investigations launched upon. The cloud module, IT network module, and email module of the cyber security appliance 100 allow visibility of email network components & IT network components and their traffic as well as visibility of cloud activity and audit logs, which can be combined into one user interface to allow pivots between the different domains, which is quite valuable. This allows the human security team to follow the trail the whole way through to reveal every component actually involved in this potential cyber attack; rather than, having to stop at various boundaries or investigate every single component in the email network, IT network, and cloud network to know what's going on, now the user can focus their time on what is relevant. The forensic acquisition investigation can occur on a component in the cloud, like a container, but also on a component, such as an endpoint computing device through its endpoint agent, on a network server, etc. Note, a forensic acquisition investigation will still do a full disk capture on an endpoint device such as a laptop even when, for example, an endpoint agent is not resident on that component. Note, the forensic artifacts from the components investigated can be displayed on the user interface based upon their interconnected systems, rather than being connected together just because of their involvement in an ongoing incident.

FIG. 2 illustrates a diagram of an embodiment of the forensic acquisition and investigation service that receives the trigger signal, including any of i) the alert, ii) the model breach, and/or iii) the cyber threat investigation, from one or more parts of the cyber security system, where one or more parts of the cyber security system include a cyber-security restoration engine, a cybersecurity appliance, a cyber threat analyst module, and a cyber-attack simulator.

The forensic acquisition and investigation service 301 is configured to receive the trigger signal, including any of i) the alert, ii) the model breach, and/or iii) the cyber threat investigation, from one or more parts of the cyber security system through an application programming interface 305. One or more parts of the cyber security system can include a cyber-security restoration engine 190 configured to restore components back to an operational state in response to a cyber attack (e.g., IR&R), a cybersecurity appliance 100 (e.g., Detect) configured to detect a presence of a cyber threat, a cyber threat analyst module 120 (e.g., an AI analyst) configured to perform the cyber threat investigation, and a cyber-attack simulator 105 to run simulations of the cyber attack by the cyber threat. The trigger signal can be communicated securely over a network to an application programming interface 305 of the forensic acquisition and investigation service 301 to trigger the launch of the forensic acquisition investigation on the components.

Multiple different ways are implemented that can trigger the forensic acquisition investigation. For example, a cyber threat investigation produced from a cyber threat analyst module 120 can trigger the forensic acquisition investigation. Also, a model breach and/or an alert from the cyber security appliance 100 can trigger the forensic acquisition investigation. These can be set to trigger when the cyber threat investigation, model breach, or alert i) goes over a certain threshold for degree of threat, degree of most anomalous asset, etc., to trigger the forensic acquisition investigation.

In another example, based upon user preference, when the cyber threat investigation, the model breach or the alert i) goes over a certain threshold, then that can automatically trigger the forensic acquisition investigation itself or merely generate a prompt on the user interface and/or an electronic message (e.g., text, email, e notice, etc.) to the user to allow the user to manually invoke the forensic acquisition investigation. The user interface is scripted to allow the user to configure certain such situations, or certain assets being involved, or other preferences of when they would like to prompt a forensic acquisition investigation itself or merely generate the notice. Human users from the notice sent and/or on the user interface can also manually trigger a forensic acquisition investigation for any cloud component, IT network component, and/or email component protected by the cyber-security restoration engine 190, the cyber security appliance, the cyber threat analyst module 120, and/or the cyber-attack simulator 105.

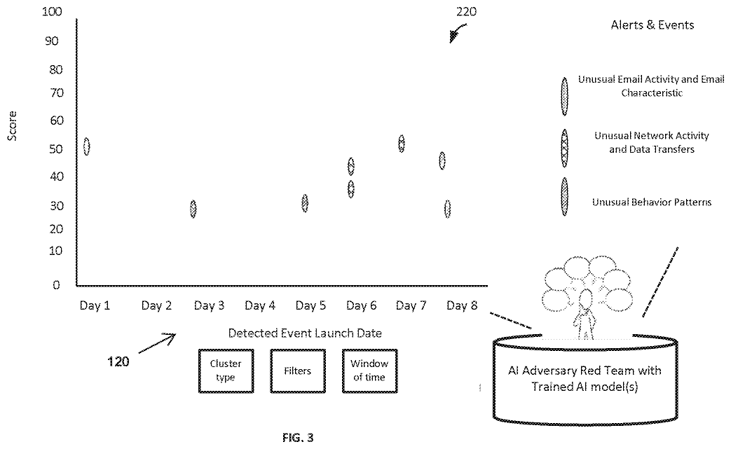

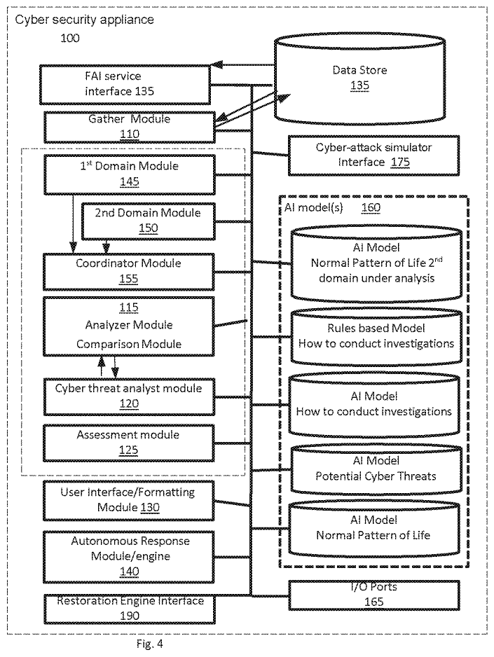

Next, a part of the cyber security system can be a cyber threat analyst module 120 (e.g., AI analyst) that performs the cyber threat investigation on a chain of two or more anomalous activities (See FIG. 3) on the components being protected by the cyber security system. When the cyber threat analyst module 120 determines a certain level of anomaly equal to or above a threshold with the cyber threat investigation, then the cyber threat analyst module 120 can be configured to automatically generate the trigger signal to the forensic acquisition and investigation service 301 to launch the forensic acquisition investigation on components protected by the cyber security system. The cyber threat analyst module 120 can be configured to automatically do its own cyber threat investigation (See FIG. 4 for more details), but in some cases, then the cyber threat analyst module 120 can also trigger a forensic acquisition investigation.

Another part of the cyber security system can be a cyber security appliance 100 that detects a cyber threat and produces alerts and model breaches as part of that cyber threat detection process. The cyber security appliance 100 uses AI models trained with machine learning on a normal pattern of life for entities in the network(s)/domain(s) under analysis to detect deviations from the pattern of life, as well as other AI classifiers and models to detect preset conditions, etc. (See FIG. 4 for more details) The alerts and model breaches can be triggers for a forensic acquisition investigation on components protected by the cyber security system.

In an example, a cloud module 150 in the cyber security appliance 100 can trigger a forensic acquisition investigation on components in cloud architectures presented on the cloud user interface of the cyber security appliance. When the cloud module 150 cooperating with the AI model 160 trained with machine learning on a normal pattern of life for entities in the network and the assessment module 125 determine a certain level of anomaly, and potentially detects some kind of activity, then that triggers the trigger signal to the forensic acquisition and investigation service 301 to automatically launch the forensic investigation and pull in all of the forensic information on each of the components associated to ensure that the data is retained in some way. Thus, the cyber security appliance 120 can detect something unusual, which when determined to be greater than a threshold level of threat (e.g., deemed critical or at least severe, above a certain threat score, or violates a preset condition) then that triggers the forensic acquisition investigation for the full incident capture of data and state on components involved in the model breach or alert in order to fully understand what happened to each component involved.

The forensic acquisition and investigation service 301 can cooperate with another part of the cyber security system, the cyber-security restoration engine 190, to give the timeline and other information produced from the forensic acquisition investigation on how to best restore that device back to its best operational state via the forensic investigation.

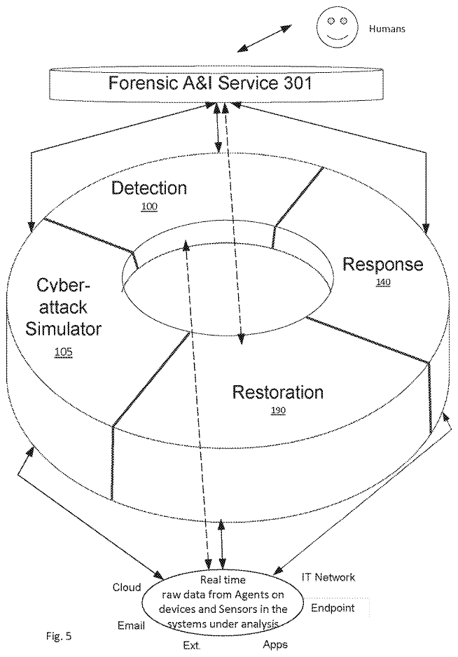

The cyber-security restoration engine 190 is configured to restore components back to an operational state in response to a cyber attack (e.g., IR&R, see FIGS. 5, 6, and 7). The cyber-security restoration engine 190 is configured to automatically generate the trigger signal to the forensic acquisition and investigation service 301 to launch the forensic acquisition investigation as an action from an incident readiness and recovery playbook. Thus, the cyber-security restoration engine 190 can trigger a forensic acquisition investigation on components indicated by the cyber threat investigation to automatically forensically investigate that component in an IT network, email network, cloud component, etc., as part of the incident readiness and recovery as an action from a playbook. The incident readiness and recovery action can direct the forensic acquisition investigation to take multiple snapshots of data and state during different stages of an incident. The forensic acquisition investigation working with the cyber-security restoration engine 190 can be driven and/or augmented, by human cyber analysts, so when a user sees an ongoing cyber attack, then the user can look at the components that are currently involved, and other components that can be likely acquired and brought into this incident. Note, a cyber threat investigation from a cyber threat analyst module 120 can push action through an alert translator integration into an incident response playbook implemented by the cyber-security restoration engine 190. As different stages of a cyber attack progress, each new stage triggers a forensic acquisition investigation to capture snapshots of information of components invoked in the cyber attack. Again, on the user interface, the information from the cyber attack and its multiple stages of the cyber attack captured by the forensic acquisition investigation can be summed up so that the user can see on the user interface the complete picture of the incident.

Again, the forensic acquisition and investigation service 301 securely gets inputs/trigger signals from one or more parts of the cyber security system including the cyber-security restoration engine 190 (e.g., IR&R), the cybersecurity appliance 100 (e.g., Detect), the cyber threat analyst module 120 (e.g., AI analyst), and the cyber-attack simulator 105. One or more parts of the cyber security system and the forensic acquisition and investigation service 301 both communicate in a secure, authenticated manner with each other through secure communication tunnels along with one or more additional authentication steps, such as computer-to-computer authentication over the internet with Mutual TLS (mTLS), OAuth 2.0 Client Credentials, and application programming interface 305 keys. Each of these components of the cyber-security restoration engine 190, the cybersecurity appliance, the cyber threat analyst module 120, and the cyber-attack simulator 105, each can send their own trigger signal securely to go over an application programming interface 305 to the forensic acquisition and investigation service 301. The forensic acquisition and investigation service 301 launches a forensic acquisition investigation with a script to take one or more snapshots of the information on that component, and then there is a feedback loop of going back to the components of the cyber-security restoration engine 190, the cybersecurity appliance, the cyber threat analyst module 120, and the cyber-attack simulator 105 after the forensic acquisition and investigation service 301 takes one or more snapshots, possibly is given instructions to take additional snapshots, and putting that captured information into storage in the forensic database 309. The forensic investigation and acquisition service aggregates the alert and/or investigation information along with the artifacts of the forensic acquisition investigation and allows that aggregated information to be pulled through the bidirectional application programming interface 305 to a user interface on that part of the cyber security system to be drawn back from the forensic investigation and acquisition service. The aggregated information is presented onto a user interface on that part of the cyber security system so that the user can see a whole picture of the forensically captured information. A trigger signal of an alert and/or cyber threat investigation is sent over to the forensic acquisition and investigation service 301 to go ahead and take its initial snap shot, and then as the investigation progresses on what components inside the system are involved, the forensic acquisition and investigation service 301 is going to take additional snapshots of information including operational state information, configuration settings, disk data, and ephemeral process data, and other things on all of the components (including physical assets and virtual assets) involved in the initial alert and/or cyber threat investigation as well as any subsequent components involved. The forensic acquisition and investigation service 301 then displays all of that back to the user on the user interface. The user interface can show the raw data from the snapshot of the state, data, etc. In addition, the LLM investigation summary generator 313, a LLM trained to analyze forensic acquisition data, can review the snapshots of state, data, etc. on a component and then output a short written summary based regarding the state and data of that component for possible display on the user interface. Generally, the cyber-security restoration engine 190, the cybersecurity appliance, the cyber threat analyst module 120, and their alerts, the model breaches, etc., list and rank the most serious alerts and, for example, the top ten ranked most serious can have an automated forensic acquisition investigation initiated.

The forensic acquisition and investigation service 301 receives a trigger signal from one or more parts of a cyber security system to provide automated forensics capabilities to protect a hybrid email network, IT network, and cloud based components in multi-cloud security networks. The forensic acquisition and investigation service 301 and cyber security system gain unified detection, response, and forensic investigation at scale. The forensic acquisition and investigation service 301 receives trigger signals from one or more parts of the cyber security system that provide a high confidence indication that at least unusual activity that's going on as detected by a part of the AI cyber security system, which is then communicated securely to an application programming interface 305 of the forensic acquisition and investigation service 301 allowing that to automatically trigger a launch of a forensic acquisition investigation on components associated with the alert and/or cyber incident indicated in the alert and/or cyber incident, with information captured with the forensic acquisition investigation on the components can then be fed back into one or more parts of the cyber security system, in particular, especially within the incident readiness and response case in the cyber security restoration engine 190, to the incident response, giving users further evidence, to look at, as well as marrying, activity that we have identified within the cyber security appliance 100 to the additional evidence on the components from the forensic acquisition and investigation service 301.

Another scenario is to trigger a forensic acquisition investigation on components indicated on the user interface with a manual button on that user interface that has been script to trigger a forensic acquisition investigation on that component displayed on that user interface. The user can initiate this forensic acquisition investigation at any time by activating the icon on the UI. For example, the user interface can represent a cloud architecture to an end user on the user interface along with different kinds of factors of risk and stuff on the components of those cloud architectures. The activate element (e.g., button) on the user interface showing these components gives the capacity to just manually launch a forensic capture by a user which launches the forensic acquisition investigation and then show the forensic acquisition investigation on that component, as well as have a section to show every previous investigation on the user interface.

Another part of the cyber security system is a cyber-attack simulator 105 configured to run simulations of a cyber attack by a cyber threat (see FIGS. 5, 6, and 7 and this FIG. 2 discussed later on). The cyber-attack simulator 105 is configured to automatically generate the trigger signal to the forensic acquisition and investigation service 301 to launch the forensic acquisition investigation on the components in a likely attack path. Components involved in the cyber attack will be noted during the runs of simulations of a cyber attack by a cyber threat. A determination on components involved in a likely attack path can be made. The cyber attack simulator 105 identifies the users and devices involved in the cyber attack including what other devices do they use, in order to trigger the forensic acquisition investigation to perform a full scan and snapshot of those devices. This kind of scenario triggering a forensic acquisition investigation on components indicated by the cyber attack simulator 105 occurs as a future exposure management exercise. Thus, this future exposure management scenario, by running a cyber attack simulation on the cyber attack simulator 105, can trigger a forensic acquisition investigation. When the cyber attack simulator 105 finds some likely attack paths in the network being protected, then the forensic acquisition investigation is proactively launched on components in the most likely attack path in order to get some information about these components in this attack path. The cyber-attack simulator 105 provides automated posture checks and attack path modelling that surface misconfigurations and exposures before attackers can exploit them. The cyber-attack simulator 105 can proactively simulate, for example, cloud-based attacks and then run hundreds of variants, allowing the user to progress step by step through the attack to simplify life for the users. The cyber-attack simulator 105 can examine and test out cyber threat risks that can be complex to manage.

Next, another part of the cyber security system is an endpoint agent resident on an endpoint computing device. The forensic acquisition and investigation service 301 is configured to receive the trigger signal on at least one of an alert and/or a model breach involving the endpoint computing device with the endpoint agent resident. The forensic acquisition and investigation service 301 is configured to send a command to the endpoint agent on the endpoint computing device to invoke the endpoint agent to capture the information including at least an operational state data, configuration settings, disk data, and process data on that endpoint computing device with time stamps of a point in time of the capture, and then to receive that that information back over a network to create a forensic artifact to be saved in the forensic database 309. Again, the forensic acquisition and investigation service 301 can receive an alert or model breach involving an endpoint computing device with an endpoint agent resident on the endpoint computing device. The alert or model breach involving an endpoint computing device can trigger the forensic acquisition and investigation service 301 to send a command to the endpoint agent on the endpoint computing device (e.g., laptop computer, desk top computer, smart phone, etc.) to invoke the endpoint agent on laptops to capture operational state data, configuration settings, disk data, and process data on that endpoint computing device with time stamps at the point in time and then receive that data and forensically format that information to create a forensic artifact to be saved in a database.

Again, the alert, model breach, and/or cyber threat incident from a part of the cyber security system supplies a high confidence reason (exceeded some threshold or preset condition) to have detected something of interest, some form of anomaly, without there being a requirement that it be a specific known cyber threat but still invokes a forensic acquisition investigation of components involved.

Next, the cloud module 150 cooperating with the AI models 160 in the cyber security appliance 100 gives cloud cyber security protection. In general, cloud adoption has outpaced security operations, creating blind spots that cyber threat adversaries are quick to exploit. Many organizations report suffering damage before they can contain cloud incidents because forensic investigations typically take three days to complete with a human on cloud incidents. The forensic acquisition and investigation service 301 captures log-based behaviors, such as lateral movement or privilege escalation, and evidence from ephemeral components like containers and serverless functions that often disappear before the ephemeral process data can be collected, which leaves human security teams to struggle to respond effectively. At the same time, cyber attacks against cloud workloads are increasingly aggressive arriving in sudden bursts, generating high volumes of cyber attacks in a short period of time from a persistent cyber threat attacker. The forensic acquisition and investigation service 301 cooperating with the parts of a cyber security system receives the trigger signal to launch the forensic acquisition investigation into cloud components targeted by a cyber attack to capture at scale within a short time window to investigate and capture information before critical evidence disappears. The forensic acquisition and investigation service 301 cooperating with the parts of a cyber security system provides an automated forensic investigation solution designed for the speed and complexity of modern cloud environments to capture and analyze host-level evidence, including disk, memory, and logs, at the exact moment a cyber threat is detected, even from short-lived assets such as containers or serverless workloads.

As discussed in more detail in FIG. 4, the cybersecurity appliance 100 provides autonomous detection and response for IT network components, email components, as well as cloud-based components. The cybersecurity appliance 100 uses self-learning AI that continuously monitors cloud environments to spot both known and novel threats and automatically contain them at machine speed. The cloud module 150 of the cybersecurity appliance 100 provides dynamic cloud visibility. The cloud module 150 of the cybersecurity appliance 100 provides live mapping of components, services, and architectures to reveal blind spots, track attacker movement, and provide real-time context. The cloud module 150 of the cybersecurity appliance 100 provides visibility for the entire cloud architecture on a user interface and cooperates with the forensic acquisition and investigation service 301 to prioritize investigations and save valuable time while keeping the network secure.

The forensic acquisition and investigation service 301 collects evidence directly through the application programming interfaces of cloud provider services and local cloud-based sensors monitoring a cloud component to ensure investigations begin instantly; and thus, critical data from ephemeral workloads is never lost. By preserving volatile ephemeral data and reconstructing cyber attacker behavior in real time, the forensic acquisition and investigation service 301 adds critical context to everyday investigations, enabling security teams to understand root causes quickly and shorten investigation times from days to mere minutes to allow all significant cloud alerts to be investigated.

Note, cloud investigations are notoriously complex and heavily involve manual efforts to investigate, with evidence scattered across fragmented logs and ephemeral assets that often disappear before they can be collected. The forensic acquisition and investigation service 301 collects the information from all of these sources and aggregates them for subsequent presentation on the user interface. The forensic acquisition and investigation service 301 automates cloud forensics that leverages the speed and scale of a cloud platform to automatically collect, preserve, and investigate volatile ephemeral data at the time of detection, enabling security teams to investigate faster, respond more effectively, and reduce overall business risk.

Overall, the forensic acquisition and investigation service 301 works together seamlessly with the parts of the cyber security system to detect cyber threats as they emerge and preserve the forensic evidence needed to investigate them. The cloud module 150 of the cyber security appliance 100 detects and blocks suspicious cloud activity as well as tracks all suspicious anomalies with alerts and model breaches. The forensic acquisition and investigation service 301 captures disk, memory, and log data from the affected component, allowing security teams to immediately contain threats while preserving the critical evidence needed to investigate and remediate the incident. The user interface 130 and cloud module 150 of the cyber security appliance 100 present intuitive cloud architecture diagrams that make complex environments easier to interpret, along with expanded detection of advanced attacker techniques such as lateral movement, command-and-control, and privilege escalation.

The cyber security appliance 100 is powered by self-learning AI models 160 to correlate signals across networks, endpoints, identities, SaaS, and email to create a unified understanding of risk. Activity in one domain, such as an anomalous identity action or endpoint process, immediately informs forensic investigations in another domain, such as the cloud, and vice versa. This cross-domain intelligence enables faster detection, enriched context, and smarter autonomous actions, reducing complexity and human overhead.

The forensic acquisition and investigation service 301 cooperates with the parts of the cyber security system to unite cyber threat detection, autonomous response to mitigate the cyber threat, and automated forensics to capture information at an early part of a potential cyber attack in one platform so that security teams can shift cloud investigations from reactive and fragmented to fast, automated, and context-rich, which enables organizations to harness the benefits of the cloud while effectively mitigating risks.

### Additional Points

The forensic acquisition and investigation service 301 provides security teams immediate access to forensic-level data, equipping them with critical context to investigate threats quickly and thoroughly across hybrid, multi-cloud and on-premises environments. The forensic acquisition and investigation service 301 cooperates with the parts of a cyber security system to give organizations a complete cloud security solution that combines posture management with real-time detection, response, and forensic investigation—potentially reducing investigation times from days to mere minutes.

The forensic acquisition and investigation service 301 provides scalable response and reporting. The forensic acquisition and investigation service 301 supports parallel investigations across multiple systems and automatically generates exportable reports to help reduce analyst workload and assist with compliance burdens. The forensic acquisition and investigation service 301 provides scalable response and reporting. The forensic acquisition and investigation service 301 supports parallel investigations across multiple systems and automatically generates exportable reports to help reduce analyst workload and assist with compliance burdens.

The forensic acquisition and investigation service 301 supports rapid deployment and seamless integration. The forensic acquisition and investigation service 301 offers flexible SaaS or on-premises deployment, and integrates with existing SIEM, XDR, CNAPP, EDR, NDR, and cloud-native tools so that any alert can trigger immediate forensic capture and investigation.

The forensic acquisition and investigation service 301 provides immediate access to automated cloud forensics to support a Security Operations Center and incident response security teams in their day-to-day management of cloud security threats and is integrated across the parts of AI cyber security system for end-to-end investigations and response across an organization's entire digital estate. The forensic acquisition and investigation service 301 is particularly powerful when paired with the cloud module in the cyber security appliance, where the two parts bring together real-time cloud detection of a cyber threat, automated response to mitigate the cyber attack, and forensic-level investigation in a single workflow. The modules and models of the cybersecurity appliance 100 supply cloud detection and response as well as autonomous detection of cyber threats across all components in the network being protected.

The forensic acquisition and investigation service 301 is able to investigate cloud alerts and triage before a component's data changes or disappears to better evaluate the alerts.

The forensic acquisition investigation provides the forensic depth needed to fully understand the attack and allowing remediation to be complete, decreasing a risk for future compromise.

The forensic acquisition investigation provides analysts a mechanism for alerts that can be easily triaged, resulting in saved time, elimination of false positives, alerts being closed with a complete understanding, and catching more cyber threats altogether. The forensic acquisition investigation reveals active cyber attacker behaviors such as lateral movement, privilege escalation, and command-and-control from logs and data allowing cyber threat adversaries' movement to be detected. At the same time, ephemeral assets like containers and serverless functions generally disappear before evidence can be collected, creating blind spots in investigations but now are captured. The forensic acquisition and investigation service 301 provides the visibility, scale, or speed required to keep investigations effective along with the ability to triage and track those investigations across the IT network, the cloud network, incident readiness and response, and other domains in a single unifying interface.

For security teams, the challenge is alert volume and context. Analysts are buried under floods of alerts from multiple tools, many of which lack the forensic depth needed to confirm or dismiss a threat. The forensic acquisition and investigation service 301 provides automated and manual triage capabilities to avoid alert fatigue and to not waste valuable time. The forensic acquisition investigation is coded to use collecting scripts to collect information on ephemeral assets and collect siloed log data make it easier to correlate activity or trace attacker movement. The forensic acquisition and investigation service 301 allows easier viewing of the clear root cause, to prevent SOC teams from being forced to escalate prematurely or close alerts without full confidence, leaving adversaries with less room and time to maneuver before discovery and remediation actions are taken.

The script for the forensic acquisition investigation instantly captures full disk snap shots, requests third party logs, captures cross cloud investigation and triage, including container investigations with IT network components, and preserves host-level evidence the moment a threat is detected, status of the investigation and the containment of the incident, even from ephemeral workloads like containers or serverless resources.

The forensic acquisition investigation is coded to keep pace with ephemeral cloud workloads that may exist only for minutes. When incidents occur, multiple triggers can launch a forensic acquisition investigation to evoke scripts to instantly investigate to capture a cloud component snapshot, requesting access and information from internal sources as well as from third party providers. The forensic acquisition and investigation service 301 provides a unified approach to detection, response, and forensic investigation, so that all critical alerts over a set threshold are investigated, threat escalation is noticed, and organizations are not left vulnerable, all at cloud speed.

The forensic acquisition investigation transforms incident response from slow and fragmented into fast, scalable, and forensically sound. The forensic acquisition investigation allows security teams to quickly uncover root cause, reconstruct attacker timelines, and investigate across AWS, Azure, GCP, SaaS, and on-prem environments, all within a single user interface.

The forensic acquisition and investigation service 301 has a cloud-native architecture that seamlessly spans AWS, Azure, GCP, containers, SaaS, and on-prem workloads. The network being protected can be deployed across hundreds of accounts and multiple regions. The forensic acquisition and investigation service 301 scales instantly via application programming interface 305 integration, eliminating the friction and delays of manual evidence collection. The forensic acquisition investigation can be triggered by alerts from any detection source—EDR, XDR, CNAPP, SIEM, or cloud-native tools—ensuring teams can rapidly pivot from detection to deep forensic investigation without switching contexts or waiting for manual processes. This flexibility allows organizations to extend forensic-level visibility and investigation capabilities across every environment, delivering the scale and agility today's hybrid enterprises demand. The result is faster, more consistent investigations that strengthen response while reducing operational overhead.

The forensic acquisition and investigation service 301 automates evidence collection, one of the most time-consuming and error-prone parts of incident response. Instead of relying on tickets, snapshots, or manual processes that often miss time-sensitive workloads, the forensic acquisition and investigation service 301 instantly captures forensic evidence the moment a threat is detected. Full disk and memory can be acquired automatically, including from ephemeral assets like containers or serverless functions that would otherwise vanish before analysts could investigate. The forensic acquisition and investigation service 301 works with scripts to access and copy information from different types of components in a network, reducing deployment overhead needed with putting an agent on every component and ensuring that collection does not disrupt workloads.

### Additional Details

The following text below discusses how some of the other components in the cyber security system operate; and thus, how these components respond to the commands, requests, and communications from the cyber security system.

FIG. 4 illustrates a block diagram of an embodiment of the AI-based cyber security appliance with example components making up a detection engine that protects a system, including but not limited to a network/domain, from cyber threats.

Various Artificial Intelligence models and modules of the cyber security appliance 100 cooperate to protect a system, such as one or more networks/domains under analysis, from cyber threats. In an embodiment, the AI-based cyber security appliance 100 may include a trigger module, a gather module 110, an analyzer module 115, a cyber threat analyst module 120, an assessment module 125, a user interface and formatting module 130, a data store 135, an autonomous response module 140 and/or an interface to an autonomous response module 140, an Information Technology network domain module 145, a cloud domain module 150, and a coordinator module 155, one or more AI models 160 (hereinafter, AI model(s)”), a forensic acquisition and investigation service 135, and/or other modules. The AI model(s) 160 may be trained i) with machine learning on a normal pattern of life for entities in the network(s)/domain(s) under analysis, ii) with machine learning on cyber threat hypotheses to form and investigate a cyber threat, iii) on what are a possible set of cyber threats and their characteristics, symptoms, remediations, etc., an interface to a restoration engine 190, an interface to a cyber-attack simulator 105, and other similar components. The forensic acquisition and investigation service interface can bilaterally communicate with the application programming interface of the forensic acquisition and investigation service 301 as discussed in FIGS. 1 and 2.

The cyber security appliance 100 can host the cyber threat detection engine and other components. The cyber security appliance 100 includes a set of modules cooperating with one or more Artificial Intelligence models configured to perform a machine-learned task of detecting a cyber threat incident. The detection engine uses the set of modules cooperating with the one or more Artificial Intelligence models in the cyber security appliance 100 to prevent a cyber threat from compromising the nodes (e.g. devices, end users, etc.) and/or spreading through the nodes of the network being protected by the cyber security appliance 100.

The cyber security appliance 100 with the Artificial Intelligence (AI)-based cyber security system may protect a network/domain from a cyber threat (insider attack, malicious files, malicious emails, etc.). The cyber security appliance 100 can protect all of the devices on the network(s)/domain(s) being monitored. For example, the IT network domain module (e.g., first domain module 145) may communicate with network sensors to monitor network traffic going to and from the computing devices on the network as well as receive secure communications from software agents embedded in host computing devices/containers. Other domain modules such as the email domain module and a cloud domain module operate similarly with their domain. The steps below will detail the activities and functions of several of the components in the cyber security appliance 100.

The gather module 110 may be configured with one or more process identifier classifiers. Each process identifier classifier may be configured to identify and track one or more processes and/or devices in the network, under analysis, making communication connections. The data store 135 cooperates with the process identifier classifier to collect and maintain historical data of processes and their connections, which is updated over time as the network is in operation. In an example, the process identifier classifier can identify each process running on a given device along with its endpoint connections, which are stored in the data store 135. In addition, a feature classifier can examine and determine features in the data being analyzed into different categories.

The analyzer module 115 can cooperate with the AI model(s) 160 or other modules in the cyber security appliance 100 to confirm a presence of a cyber threat in cyberattack against one or more domains in an enterprise's system (e.g., see system/enterprise network 791, 792, and 747 of FIG. 2). A process identifier in the analyzer module 115 can cooperate with the gather module 110 to collect any additional data and metrics to support a possible cyber threat hypothesis. Similarly, the cyber threat analyst module 120 can cooperate with the internal data sources as well as external data sources to collect data in its investigation. More specifically, the cyber threat analyst module 120 can cooperate with the other modules and the AI model(s) 160 in the cyber security appliance 100 to conduct a long-term investigation and/or a more in-depth investigation of potential and emerging cyber threats directed to one or more domains in an enterprise's system. Herein, the cyber threat analyst module 120 and/or the analyzer module 115 can also monitor for other anomalies, such as model breaches, including, for example, deviations for a normal behavior of an entity, and other techniques discussed herein. The analyzer module 115 and/or the cyber threat analyst module 120 can cooperate with the AI model(s) 160 trained on potential cyber threats in order to assist in examining and factoring these additional data points that have occurred over a given timeframe to see if a correlation exists between 1) a series of two or more anomalies occurring within that time frame and 2) possible known and unknown cyber threats.

The cyber threat analyst module 120 allows two levels of investigations of a cyber threat that may suggest a potential impending cyberattack. In a first level of investigation, the analyzer module 115 and AI model(s) 160 can rapidly detect and then the autonomous response module 140 will autonomously respond to overt and obvious cyberattacks (generally indicated by high scores of 80 or more see FIG. 3). However, thousands to millions of low level anomalies occur in a domain under analysis all of the time; and thus, most other systems need to set the threshold of trying to detect a cyberattack by a cyber threat at level higher such as a score of 80 or more than the low level anomalies examined by the cyber threat analyst module 120 just to not have too many false positive indications of a cyberattack when one is not actually occurring, as well as to not overwhelm a human cyber security analyst receiving the alerts with so many notifications of low level anomalies that they just start tuning out those alerts. However, advanced persistent threats attempt to avoid detection by making these low-level anomalies in the system over time during their cyberattack before making their final coup de grace/ultimate mortal blow against the system (e.g., domain) being protected. The cyber threat analyst module 120 also conducts a second level of investigation over time with the assistance of the AI model(s) 160 trained with machine learning on how to form cyber threat hypotheses and how to conduct investigations for a cyber threat hypothesis that can detect these advanced persistent cyber threats actively trying to avoid detection by looking at one or more of these low-level anomalies combined in with other anomalies and factors as a part of a chain of linked information (See FIG. 3).

The artificial intelligence-based cyber security analyst tool can use the cyber threat analyst module 120 and its interaction with the other modules and AI models 160 in the cyber security appliance 100. The artificial intelligence-based cyber security analyst tool's investigations into potential cyber-attacks from potential cyber threats has the ability for customers to review the outcomes of the artificial intelligence-based cyber security analyst tool's investigations at the hypothesis-level (hypothesis steps taken and investigation steps taken and then its conclusion) and a human readable summary on why the system took the hypothesis steps taken and investigation steps taken and then its conclusion. For every compatible DETECT alert (e.g. model breach), the artificial intelligence-based cyber security analyst tool investigates a series of possible relevant hypotheses, and we try and find data and find activity that meets the criteria, those hypotheses. When artificial intelligence-based cyber security analyst tool finds activity and/or data that meets the criteria that actually support a likelihood of a hypothesis, then those hypotheses are worth surfacing to an operator. The artificial intelligence-based cyber security analyst tool presents the most salient information to the end user. The artificial intelligence-based cyber security analyst autonomously investigates alerts, streamlines investigations, and prioritizes incidents, thus reducing workload and alert fatigue. The artificial intelligence-based cyber security analyst uses various forms of machine learning, including unsupervised, supervised, and deep learning combined with human intuition and trade craft from hundreds of world-class human cyber analysts across thousands of customer deployments. The artificial intelligence-based cyber security analyst relieves a human cyber analyst from spend anywhere between half an hour and half a day investigating a single suspicious security incident. The artificial intelligence-based cyber security analyst looks for patterns, forms hypotheses, reaches conclusions about how to mitigate the threat, and shares the findings with the rest of the business. The artificial intelligence-based cyber security analyst continuously conducts investigations behind the scenes and operating at a speed and scale beyond human capabilities. The artificial intelligence-based cyber security analyst tool as a large language model (LLM) is built to incorporate cyber threat knowledge from external data stores, external data sources, as well as from a network's own cyber security appliance. The artificial intelligence-based cyber security analyst tool uses threat intelligence to understand a cyber threat adversary tactics and motivations. An effectiveness of the artificial intelligence-based cyber security analyst tool lies in its ability to access and integrate diverse data sources. The artificial intelligence-based cyber security analyst can tap into external data stores, such as threat intelligence platforms and vulnerability databases, to enrich its understanding of the threat landscape.

The cyber threat analyst module 120 forms in conjunction with the AI model(s) 160 trained with machine learning on how to form cyber threat hypotheses and how to conduct investigations for a cyber threat hypothesis investigate hypotheses on what are a possible set of cyber threats. The cyber threat analyst module 120 can also cooperate with the analyzer module 115 with its one or more data analysis processes to conduct an investigation on a possible set of cyber threats hypotheses that would include an anomaly of at least one of i) the abnormal behavior, ii) the suspicious activity, and iii) any combination of both, identified through cooperation with, for example, the AI model(s) 160 trained with machine learning on the normal pattern of life of entities in the system. For example, as shown in FIG. 3, the cyber threat analyst module 120 may perform several additional rounds 220 of gathering additional information, including abnormal behavior, over a period of time, in this example, examining data over a 7-day period to determine causal links between the information. The cyber threat analyst module 120 may submit to check and recheck various combinations/a chain of potentially related information, including abnormal behavior of a device/user account under analysis for example, until each of the one or more hypotheses on potential cyber threats are one of 1) refuted, 2) supported, or 3) included in a report that includes details of activities assessed to be relevant activities to the anomaly of interest to the user and that also conveys at least this particular hypothesis was neither supported or refuted. For this embodiment, a human cyber security analyst is then needed to further investigate the anomaly (and/or anomalies) of interest included in the chain of potentially related information.

Returning back to FIG. 4, an input from the cyber threat analyst module 120 of a supported hypothesis of a potential cyber threat will trigger the analyzer module 115 and/or assessment module 125 to compare, confirm, and send a signal to act upon and mitigate that cyber threat. In contrast, the cyber threat analyst module 120 investigates subtle indicators and/or initially seemingly isolated unusual or suspicious activity such as a worker is logging in after their normal working hours or a simple system misconfiguration has occurred. Most of the investigations conducted by the cyber threat analyst module 120 cooperating with the AI model(s) 160 trained with machine learning on how to form cyber threat hypotheses and how to conduct investigations for a cyber threat hypothesis on unusual or suspicious activities/behavior may not result in a cyber threat hypothesis that is supported but rather most cyber threat hypotheses are refuted or simply not supported. Typically, during the investigations, several rounds of data gathering to support or refute the long list of potential cyber threat hypotheses formed by the cyber threat analyst module 120 will occur before the algorithms in the cyber threat analyst module 120 will determine whether a particular cyber threat hypothesis is supported, refuted, or needs further investigation by a human. The rounds of data gathering will build chains of linked low-level indicators of unusual activity along with potential activities that could be within a normal pattern of life for that entity to evaluate the whole chain of activities to support or refute each potential cyber threat hypothesis formed. (See again, for example, FIG. 3 and a chain of linked low-level indicators, including abnormal behavior compared to the normal patten of life for that entity, all under a score of 50 on a threat indicator score). The investigations by the cyber threat analyst module 120 can happen over a relatively long period of time (e.g. a week or longer) and be far more in depth than the analyzer module 115 which will work with the other modules and AI model(s) 160 to confirm that a cyber threat has in fact been detected by the presence of an anomaly with a score of 75 or more and/or the occurrence of a specific event deemed a serious cyber threat in itself occurring.

The gather module 110 cooperates with the cyber threat analyst module 120 and/or analyzer module 115 to collect data to support or to refute each of the one or more possible cyber threat hypotheses that could include this abnormal behavior or suspicious activity by cooperating with one or more of the cyber threat hypotheses mechanisms to form and investigate hypotheses on what are a possible set of cyber threats.

Thus, the cyber threat analyst module 120 is configured to cooperate with the AI model(s) 160 trained with machine learning on how to form cyber threat hypotheses and how to conduct investigations for a cyber threat hypothesis to form and investigate hypotheses on what are a possible set of cyber threats and then can cooperate with the analyzer module 115 with the one or more data analysis processes to confirm the results of the investigation on the possible set of cyber threats hypotheses that would include the at least one of i) the abnormal behavior, ii) the suspicious activity, and iii) any combination of both, identified through cooperation with the AI model(s) 160 trained with machine learning on the normal pattern of life/normal behavior of entities in the domains under analysis.

Note, in the first level of threat detection, the gather module 110 and the analyzer module 115 cooperate to supply any data and/or metrics requested by the analyzer module 115 cooperating with the AI model(s) 160 trained on possible cyber threats to support or rebut each possible type of cyber threat and generally that presence of an anomaly with a high threat/anomaly score and/or the occurrence of a specific event deemed a serious cyber threat in itself, will cause the analyzer module 115 to send a signal and this information to the autonomous response module 140. Again, the analyzer module 115 can cooperate with the AI model(s) 160 and/or other modules to rapidly detect and then cooperate with the autonomous response module 140 to autonomously respond to overt and obvious cyberattacks, (including ones found to be supported by the cyber threat analyst module 120).

As a starting point, the AI-based cyber security appliance 100 can use multiple modules, each capable of identifying abnormal behavior and/or suspicious activity against the AI model(s) 160 trained on a normal pattern of life for the entities in the network/domain under analysis, which is supplied to the analyzer module 115 and/or the cyber threat analyst module 120. The analyzer module 115 and/or the cyber threat analyst module 120 may also receive other inputs such as AI model breaches, AI classifier breaches, etc. a trigger to start an investigation from an external source.

Many other model breaches of the AI model(s) 160 trained with machine learning on the normal behavior of the system can send an input into the cyber threat analyst module 120 and/or the trigger module to trigger an investigation to start the formation of one or more hypotheses on what are a possible set of cyber threats that could include the initially identified abnormal behavior and/or suspicious activity.

The cyber threat analyst module 120, which forms and investigates hypotheses on what are the possible set of cyber threats, can use hypotheses mechanisms including any of 1) one or more of the AI model(s) 160 trained on how human cyber security analysts form cyber threat hypotheses and how to conduct investigations for a cyber threat hypothesis that would include at least an anomaly of interest, 2) one or more scripts outlining how to conduct an investigation on a possible set of cyber threats hypotheses that would include at least the anomaly of interest, 3) one or more rules-based models on how to conduct an investigation on a possible set of cyber threats hypotheses and how to form a possible set of cyber threats hypotheses that would include at least the anomaly of interest, and 4) any combination of these. Again, the AI model(s) 160 trained on ‘how to form cyber threat hypotheses and how to conduct investigations for a cyber threat hypothesis’ may use supervised machine learning on human-led cyber threat investigations and then steps, data, metrics, and metadata on how to support or to refute a plurality of the possible cyber threat hypotheses, and then the scripts and rules-based models will include the steps, data, metrics, and metadata on how to support or to refute the plurality of the possible cyber threat hypotheses. The cyber threat analyst module 120 and/or the analyzer module 115 can feed the cyber threat details to the assessment module 125 to generate a threat risk score that indicate a level of severity of the cyber threat.

Each Artificial Intelligence-based engine has an interface to communicate with another separate Artificial Intelligence-based engine, which is configured to understand a type of information and communication that this other separate Artificial Intelligence-based engine needs to make determinations on an ongoing cyberattack from that other Artificial Intelligence-based engine's perspective. The autonomous response module 140 works with the assessment module 125 in the detection engine when the cyber threat is detected and autonomously takes one or more actions to mitigate the cyber threat. FIG. 4 shows the example components making up the detection engine to include interfaces to the cyber-attack simulator 105, the autonomous response module 140, and the restoration engine 190.

The cyber threat detection engine can also have an anomaly alert system in a formatting module configured to report out anomalous incidents and events as well as the cyber threat detected to a display screen viewable by a human cyber-security professional. Each Artificial Intelligence-based engine has a rapid messaging system to communicate with a human cyber-security team to keep the human cyber-security team informed on actions autonomously taken and actions needing human approval to be taken.

FIG. 5 illustrates a diagram of an embodiment of i) the cyber security appliance 100 using Artificial Intelligence algorithms trained to perform a first machine-learned task of detecting the cyber threat, ii) an autonomous response module 140 using Artificial Intelligence algorithms trained to perform a second machine-learned task of taking one or more mitigation actions to mitigate the cyber threat, iii) a cyber-security restoration engine 190 using Artificial Intelligence algorithms trained to perform a third machine-learned task of remediating the system being protected back to a trusted operational state, and iv) a cyber-attack simulator 105 using Artificial Intelligence algorithms trained to perform a fourth machine-learned task of Artificial Intelligence-based simulations of cyberattacks to assist in determining 1) how a simulated cyberattack might occur in the system being protected, and 2) how to use the simulated cyberattack information to preempt possible escalations of an ongoing actual cyberattack, in order for these four Artificial Intelligence-based engines to work together. In addition, the intelligent orchestration component can use Artificial Intelligence algorithms trained to perform a fifth machine-learned task of adaptive interactive response between the multiple Artificial Intelligence-based engines to provide information each Artificial Intelligence engine needs to work cohesively to provide an overall incidence response that mitigates different types of cyber threats while still minimizing an impact tailored to this particular system being protected. All of these components can cooperate with the forensic acquisition and investigation service to launch a forensic acquisition investigation.

The cyber security restoration engine 190 is configured to take one or more remediation actions with Artificial Intelligence assistance to remediate the one or more nodes in the graph of the system affected by the cyberattack back to a trusted operational state in a recovery from the cyber threat. These actions might be fully automatic or require a specific human confirmation decision before they begin. The cyber security restoration engine 190 can cooperate with the other AI-based engines of the cyber security system, via the interfaces and/or direct integrations, to track and understand the cyber threat identified by the other components as well as track the one or more mitigation actions taken to mitigate the cyber threat during the cyberattack by the other components in order to assist in intelligently restoring the protected system while still mitigating the cyber threat attack back to a trusted operational state; and thus, as a situation develops with an ongoing cyberattack, the cyber security restoration engine 190 is configured to take one or more remediation actions to remediate (e.g. restore) at least one of the nodes in the graph of the network back to a trusted operational state while the cyberattack is still ongoing.

The multiple Artificial Intelligence-based engines have communication hooks in between them to exchange a significant amount of behavioral metrics including data between the multiple Artificial Intelligence-based engines to work in together to provide an overall cyber threat response.

The intelligent orchestration component can be configured as a discreet intelligent orchestration component that exists on top of the multiple Artificial Intelligence-based engines to orchestrate the overall cyber threat response and an interaction between the multiple Artificial Intelligence-based engines, each configured to perform its own machine-learned task. Alternatively, the intelligent orchestration component can be configured as a distributed collaboration with a portion of the intelligent orchestration component implemented in each of the multiple Artificial Intelligence-based engines to orchestrate the overall cyber threat response and an interaction between the multiple Artificial Intelligence-based engines. In an embodiment, whether implemented as a distributed portion on each AI engine or a discrete AI engine itself, the intelligent orchestration component can use self-learning algorithms to learn how to best assist the orchestration of the interaction between itself and the other AI engines, which also implement self-learning algorithms themselves to perform their individual machine-learned tasks better.

The multiple Artificial Intelligence-based engines can be configured to cooperate to combine an understanding of normal operations of the nodes, an understanding emerging cyber threats, an ability to contain those emerging cyber threats, and a restoration of the nodes of the system to heal the system with an adaptive feedback between the multiple Artificial Intelligence-based engines in light of simulations of the cyberattack to predict what might occur in the nodes in the system based on the progression of the attack so far, mitigation actions taken to contain those emerging cyber threats and remediation actions taken to heal the nodes using the simulated cyberattack information.

The multiple Artificial Intelligence-based engines each have an interface to communicate with the other separate Artificial Intelligence-based engines configured to understand a type of information and communication that the other separate Artificial Intelligence-based engine needs to make determinations on an ongoing cyberattack from that other Artificial Intelligence-based engine's perspective. Each Artificial Intelligence-based engine has an instant messaging system to communicate with a human cyber-security team to keep the human cyber-security team informed on actions autonomously taken and actions needing human approval as well as generate reports for the human cyber-security team.

In an example, the autonomous response module 140 uses its intelligence to cooperate with a cyber-attack simulator and its Artificial Intelligence-based simulations to choose and initiate an initial set of one or more mitigation actions indicated as a preferred targeted initial response to the detected cyber threat by autonomously initiating those mitigation actions to defend against the detected cyber threat, rather than a human taking an action. The autonomous response module 140, rather than the human taking the action, is configured to autonomously cause the one or more mitigation actions to be taken to contain the cyber threat when a threat risk parameter from an assessment module in the detection engine is equal to or above an actionable threshold. Example mitigation actions can include 1) the autonomous response module 140 monitoring and sending signals to a potentially compromised node to restrict communications of the potentially compromised node to merely normal recipients and types of communications according to the Artificial Intelligence model trained to model the normal pattern of life for each node in the protected system, 2) the autonomous response module 140 trained on how to isolate a compromised node as well as to take mitigation acts with other nodes that have a direct nexus to the compromised node.

In another example, the cyber-attack simulator 105 and its Artificial Intelligence-based simulations use intelligence to cooperate with the cyber-security restoration engine 190 to assist in choosing one or more remediation actions to perform on nodes affected by the cyberattack back to a trusted operational state while still mitigating the cyber threat during an ongoing cyberattack based on effects determined through the simulation of possible remediation actions to perform and their effects on the nodes making up the system being protected and preempt possible escalations of the cyberattack while restoring one or more nodes back to a trusted operational state.

In another example, the cyber security restoration engine 190 restores the one or more nodes in the protected system by cooperating with at least two or more of 1) an Artificial Intelligence model trained to model a normal pattern of life for each node in the protected system, 2) an Artificial Intelligence model trained on what are a possible set of cyber threats and their characteristics and symptoms to identify the cyber threat (e.g. malicious actor/device/file) that is causing a particular node to behave abnormally (e.g. malicious behavior) and fall outside of that node's normal pattern of life, and 3) the autonomous response module 140.

Referring back to FIG. 2, an embodiment of the cyber-attack simulator with Artificial Intelligence-based simulations conducts cyber-attacks by constructing a graph of nodes of the system being protected (e.g. a network) including i) the physical devices connecting to the network, any virtualized instances of the network, user accounts in the network, email accounts in the network, etc. as well as ii) connections and pathways through the network to create a virtualized instance of the network to be tested. As shown in FIG. 2, the various cooperating modules residing in the cyber-attack simulator 105 may include, but are not limited to, a collections module 705, a cyberattack generator (e.g. phishing email generator with a paraphrasing engine) 702, an email module 715, a network module 720, an analyzer module 725, a payloads module 730 with first and second payloads, a communication module 735, a training module 740, a simulated attack module 750, a cleanup module 755, a scenario module 760, a user interface 765, a reporting module, a formatting module, an orchestration module, an AI classifier with a list of specified classifiers.

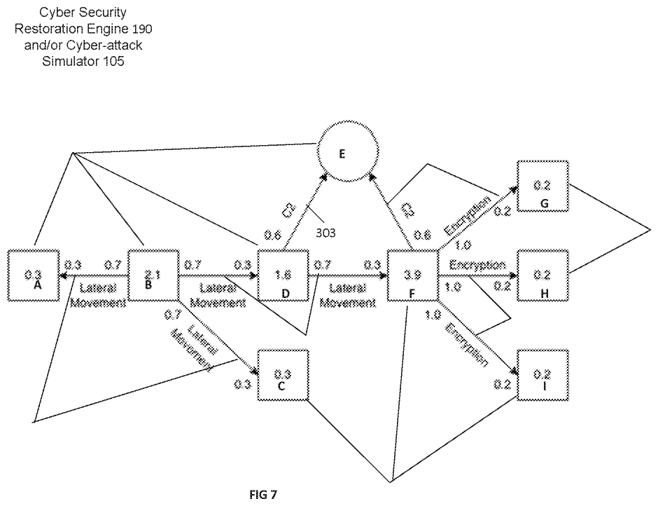

The cyber-attack simulator 105 may be implemented via i) a simulator to model the system being protected and/or ii) a clone creator to spin up a virtual network and create a virtual clone of the system being protected configured to pentest one or more defenses provided by scores based on both the level of confidence that the cyber threat is a viable threat and the severity of the cyber threat (e.g., attack type where ransomware attacks has greater severity than phishing attack; degree of infection; computing devices likely to be targeted, etc.). The threat risk scores be used to rank alerts that may be directed to enterprise or computing device administrators. This risk assessment and ranking is conducted to avoid frequent “false positive” alerts that diminish the degree of reliance/confidence on the cyber security appliance 100. The cyber-attack simulator 105 may include and cooperate with one or more AI models trained with machine learning on the contextual knowledge of the organization. These trained AI models may be configured to identify data points from the contextual knowledge of the organization and its entities, which may include, but is not limited to, language-based data, email/network connectivity and behavior pattern data, and/or historic knowledgebase data. The cyber-attack simulator 105 may use the trained AI models to cooperate with one or more AI classifier(s) by producing a list of specific organization-based classifiers for the AI classifier. The cyber-attack simulator 105 is further configured to calculate,-based at least in part on the results of the one or more hypothetical simulations of a possible cyberattack path and/or of an actual ongoing cyberattack paths from a cyber threat determine a risk score for each node (e.g. each device, user account, etc.), the threat risk score being indicative of a possible severity of the compromise prior to an autonomous response action is taken in response to the actual cyberattack of the cyber incident. See for example FIGS. 7A and 7B.

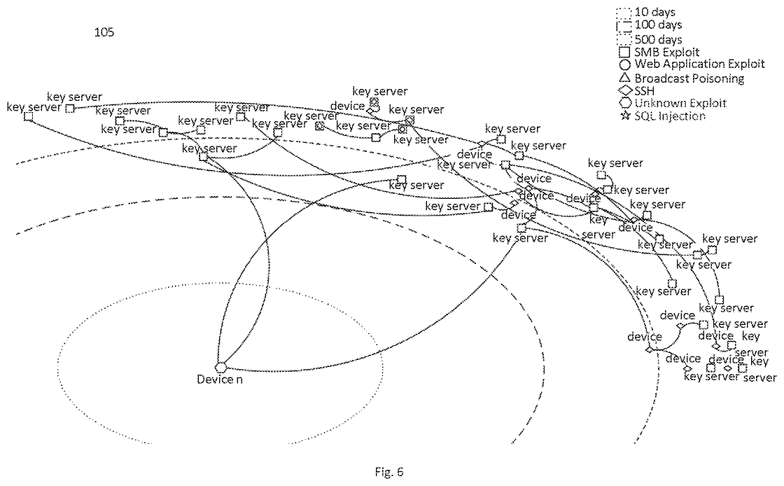

FIG. 6 illustrates a diagram of an embodiment of the cyber-attack simulator and its Artificial Intelligence-based simulations constructing an example graph of nodes in an example network and simulating how the cyberattack path might likely progress in the future tailored with an innate understanding of a normal behavior of the nodes in the system being protected and a current operational state of each node in the graph of the protected system during simulations of cyberattacks. The cyber-attack simulator 105 plots the attack path through the nodes and estimated times to reach critical nodes in the network. The cyberattack simulation modeling is run to identify the routes, difficulty, and time periods from certain entry notes to certain key servers.

Again, similarly named components in each Artificial Intelligence-based engine can 1) perform similar functions and/or 2) have a communication link from that component located in one of the Artificial Intelligence-based engines and then information is needed from that component is communicated to another Artificial Intelligence-based engine that through the interface to that Artificial Intelligence-based engine.

FIG. 7 illustrates a diagram of an embodiment of the cyber-attack simulator and/or the cyber-attack restoration engine assigning scores for a portion of the graph of nodes of the system being protected (e.g. a network) including i) the physical devices, accounts, etc. in the system, etc. as well as ii) connections and attack pathways through the network.

Training of AI Pre-Deployment and then During Deployment

In step 1, an initial training of the Artificial Intelligence model trained on cyber threats can occur using unsupervised learning and/or supervised learning on characteristics and attributes of known potential cyber threats including malware, insider threats, and other kinds of cyber threats that can occur within that domain. Each Artificial Intelligence model (e.g. neural network, decision tree, etc.) can be programmed and configured with the background information to understand and handle particulars, including different types of data, protocols used, types of devices, user accounts, etc. of the system being protected. The Artificial Intelligence pre-deployment can all be trained on the specific machine learning task that they will perform when put into deployment.

For example, the AI model, such as AI model(s) 160 or example (hereinafter “AI model(s) 160”), trained on identifying a specific cyber threat learns at least both in the pre-deployment training i) the characteristics and attributes of known potential cyber threats as well as ii) a set of characteristics and attributes of each category of potential cyber threats and their weights assigned on how indicative certain characteristics and attributes correlate to potential cyber threats of that category of threats. In this example, one of the AI models 160 trained on identifying a specific cyber threat can be trained with machine learning such as Linear Regression, Regression Trees, Non-Linear Regression, Bayesian Linear Regression, Deep learning, etc. to learn and understand the characteristics and attributes in that category of cyber threats. Later, when in deployment in a domain/network being protected by the cyber security appliance 100, the AI model trained on cyber threats can determine whether a potentially unknown threat has been detected via a number of techniques including an overlap of some of the same characteristics and attributes in that category of cyber threats. The AI model may use unsupervised learning when deployed to better learn newer and updated characteristics of cyberattacks.

In an embodiment, one or more of the AI models 160 may be trained on a normal pattern of life of entities in the system are self-learning AI model using unsupervised machine learning and machine learning algorithms to analyze patterns and ‘learn’ what is the ‘normal behavior’ of the network by analyzing data on the activity on, for example, the network level, at the device level, and at the employee level. The self-learning AI model using unsupervised machine learning understands the system under analysis' normal patterns of life in, for example, a week of being deployed on that system, and grows more bespoke with every passing minute. The AI unsupervised learning model learns patterns from the features in the day-to-day dataset and detecting abnormal data which would not have fallen into the category (cluster) of normal behavior. The self-learning AI model using unsupervised machine learning can simply be placed into an observation mode for an initial week or two when first deployed on a network/domain in order to establish an initial normal behavior for entities in the network/domain under analysis.

Thus, a deployed Artificial Intelligence model 160 trained on a normal behavior of entities in the system can be configured to observe the nodes in the system being protected. Training on a normal behavior of entities in the system can occur while monitoring for the first week or two until enough data has been observed to establish a statistically reliable set of normal operations for each node (e.g., user account, device, etc.). Initial training of one or more Artificial Intelligence models 160 trained with machine learning on a normal behavior of the pattern of life of the entities in the network/domain can occur where each type of network and/or domain will generally have some common typical behavior with each model trained specifically to understand components/devices, protocols, activity level, etc. to that type of network/system/domain. Alternatively, pre-deployment machine learning training of one or more Artificial Intelligence models trained on a normal pattern of life of entities in the system can occur. Initial training of one or more Artificial Intelligence models trained with machine learning on a normal behavior of the pattern of life of the entities in the network/domain can occur where each type of network and/or domain will generally have some common typical behavior with each model trained specifically to understand components/devices, protocols, activity level, etc. to that type of network/system/domain. What is the normal behavior of each entity within that system can be established either prior to the deployment and then adjusted during deployment or alternatively the model can simply be placed into an observation mode for an initial week or two when first deployed on a network/domain in order to establish an initial normal behavior for entities in the network/domain under analysis. During the deployment of the model, what is considered normal behavior will change as each different entity's behavior changes and will be reflected through the use of unsupervised learning in the model such as various Bayesian techniques, clustering, etc. Again, the AI models 160 can be implemented with various mechanisms, such neural networks, decision trees, etc. and combinations of these. Likewise, one or more supervised machine learning AI models 160 may be trained to create possible hypotheses and perform cyber threat investigations on agnostic examples of past historical incidents of detecting a multitude of possible types of cyber threat hypotheses previously analyzed by human cyber security analyst.

At its core, the self-learning AI models 160 that model the normal behavior (e.g. a normal pattern of life) of entities in the network mathematically characterizes what constitutes ‘normal’ behavior, based on the analysis of a large number of different measures of a device's network behavior-packet traffic and network activity/processes including server access, data volumes, timings of events, credential use, connection type, volume, and directionality of, for example, uploads/downloads into the network, file type, packet intention, admin activity, resource and information requests, command sent, etc.

### Clustering Methods

In order to model what should be considered as normal for a device or cloud container, its behavior can be analyzed in the context of other similar entities on the network. The AI models (e.g., AI model(s) 160) can use unsupervised machine learning to algorithmically identify significant groupings, a task which is virtually impossible to do manually. To create a holistic image of the relationships within the network, the AI models and AI classifiers employ a number of different clustering methods, including matrix-based clustering, density-based clustering, and hierarchical clustering techniques. The resulting clusters can then be used, for example, to inform the modeling of the normative behaviors and/or similar groupings.

The AI models and AI classifiers can employ a large-scale computational approach to understand sparse structure in models of network connectivity based on applying L1-regularization techniques (the lasso method). This allows the artificial intelligence to discover true associations between different elements of a network which can be cast as efficiently solvable convex optimization problems and yield parsimonious models. Various mathematical approaches assist.

Next, one or more supervised machine learning AI models are trained to create possible hypotheses and how to perform cyber threat investigations on agnostic examples of past historical incidents of detecting a multitude of possible types of cyber threat hypotheses previously analyzed by human cyber threat analysis. AI models 160 trained on forming and investigating hypotheses on what are a possible set of cyber threats can be trained initially with supervised learning. Thus, these AI models 160 can be trained on how to form and investigate hypotheses on what are a possible set of cyber threats and steps to take in supporting or refuting hypotheses. The AI models trained on forming and investigating hypotheses are updated with unsupervised machine learning algorithms when correctly supporting or refuting the hypotheses including what additional collected data proved to be the most useful. More on the training of the AI models that are trained to create one or more possible hypotheses and perform cyber threat investigations will be discussed later.

Next, the various Artificial Intelligence models and AI classifiers combine use of unsupervised and supervised machine learning to learn ‘on the job’—it does not depend upon solely knowledge of previous cyber threat attacks. The Artificial Intelligence models and classifiers combine use of unsupervised and supervised machine learning constantly revises assumptions about behavior, using probabilistic mathematics, that is always up to date on what a current normal behavior is, and not solely reliant on human input. The Artificial Intelligence models and classifiers combine use of unsupervised and supervised machine learning on cyber security is capable of seeing hitherto undiscovered cyber events, from a variety of threat sources, which would otherwise have gone unnoticed. Next, these cyber threats can include, for example: Insider threat—malicious or accidental, Zero-day attacks—previously unseen, novel exploits, latent vulnerabilities, machine-speed attacks—ransomware and other automated attacks that propagate and/or mutate very quickly, Cloud and SaaS-based attacks, other silent and stealthy attacks advance persistent threats, advanced spear-phishing, etc.

### Ranking the Cyber Threat

The assessment module 125 and/or cyber threat analyst module 120 of FIG. 4 can cooperate with the AI model(s) 160 trained on possible cyber threats to use AI algorithms to account for ambiguities by distinguishing between the subtly differing levels of evidence that characterize network data. Instead of generating the simple binary outputs ‘malicious’ or ‘benign,’ the AI's mathematical algorithms produce outputs marked with differing degrees of potential threat. This enables users of the system to rank alerts and notifications to the enterprise security administrator in a rigorous manner and prioritize those which most urgently require action. Meanwhile, it also assists to avoid the problem of numerous false positives associated with simply a rule-based approach.

### More on the Operation of the Cyber Security Appliance

As discussed in more detail below, the analyzer module 115 and/or cyber threat analyst module 120 can cooperate with the one or more unsupervised AI (machine learning) model 160 trained on the normal pattern of life/normal behavior in order to perform anomaly detection against the actual normal pattern of life for that system to determine whether an anomaly (e.g., the identified abnormal behavior and/or suspicious activity) is malicious or benign. In the operation of the cyber security appliance 100, the emerging cyber threat can be previously unknown, but the emerging threat landscape data 170 representative of the emerging cyber threat shares enough (or does not share enough) in common with the traits from the AI models 160 trained on cyber threats to now be identified as malicious or benign. Note, if later confirmed as malicious, then the AI models 160 trained with machine learning on possible cyber threats can update their training. Likewise, as the cyber security appliance 100 continues to operate, then the one or more AI models trained on a normal pattern of life for each of the entities in the system can be updated and trained with unsupervised machine learning algorithms. The analyzer module 115 can use any number of data analysis processes (discussed more in detail below and including the agent analyzer data analysis process here) to help obtain system data points so that this data can be fed and compared to the one or more AI models trained on a normal pattern of life, as well as the one or more machine learning models trained on potential cyber threats, as well as create and store data points with the connection fingerprints.

All of the above AI models 160 can continually learn and train with unsupervised machine learning algorithms on an ongoing basis when deployed in their system that the cyber security appliance 100 is protecting. Thus, learning and training on what is normal behavior for each user, each device, and the system overall and lowering a threshold of what is an anomaly.

### Anomaly Detection/Deviations

Anomaly detection can discover unusual data points in your dataset.

Anomaly can be a synonym for the word ‘outlier.’ Anomaly detection (or outlier detection) is the identification of rare items, events or observations which raise suspicions by differing significantly from the majority of the data. Anomalous activities can be linked to some kind of problems or rare events. Since there are tons of ways to induce a particular cyber-attack, it is very difficult to have information about all these attacks beforehand in a dataset. But, since the majority of the user activity and device activity in the system under analysis is normal, the system overtime captures almost all of the ways which indicate normal behavior. And from the inclusion-exclusion principle, if an activity under scrutiny does not give indications of normal activity, the self-learning AI model using unsupervised machine learning can predict with high confidence that the given activity is anomalous/unusual. The AI unsupervised learning model learns patterns from the features in the day to day dataset and detecting abnormal data which would not have fallen into the category (cluster) of normal behavior. The goal of the anomaly detection algorithm through the data fed to it is to learn the patterns of a normal activity so that when an anomalous activity occurs, the modules can flag the anomalies through the inclusion-exclusion principle. The goal of the anomaly detection algorithm through the data fed to it is to learn the patterns of a normal activity so that when an anomalous activity occurs, the modules can flag the anomalies through the inclusion-exclusion principle. The cyber threat module can perform its two level analysis on anomalous behavior and determine correlations.

In an example, 95% of data in a normal distribution lies within two standard-deviations from the mean. Since the likelihood of anomalies in general is very low, the modules cooperating with the AI model of normal behavior can say with high confidence that data points spread near the mean value are non-anomalous. And since the probability distribution values between mean and two standard-deviations are large enough, the modules cooperating with the AI model of normal behavior can set a value in this example range as a threshold (a parameter that can be tuned over time through the self-learning), where feature values with probability larger than this threshold indicate that the given feature's values are non-anomalous, otherwise it's anomalous.

Note, this anomaly detection can determine that a data point is anomalous/non-anomalous on the basis of a particular feature. In reality, the cyber security appliance 100 should not flag a data point as an anomaly based on a single feature. Merely, when a combination of all the probability values for all features for a given data point is calculated can the modules cooperating with the AI model of normal behavior can say with high confidence whether a data point is an anomaly or not. Anomaly detection can discover unusual data points in your dataset.

Again, the AI models trained on a normal pattern of life of entities in a network (e.g., domain) under analysis may perform the cyber threat detection through a probabilistic change in a normal behavior through the application of, for example, an unsupervised Bayesian mathematical model to detect the behavioral change in computers and computer networks. The Bayesian probabilistic approach can determine periodicity in multiple time series data and identify changes across single and multiple time series data for the purpose of anomalous behavior detection. Please reference U.S. Pat. No. 10,701,093 granted Jun. 30, 2020, titled “Anomaly alert system for cyber threat detection” for an example Bayesian probabilistic approach, which is incorporated by reference in its entirety. In addition, please reference US patent publication number “US2021273958A1 filed Feb. 26, 2021, titled “Multi-stage anomaly detection for process chains in multi-host environments” for another example anomalous behavior detector using a recurrent neural network and a bidirectional long short-term memory (LSTM), which is incorporated by reference in its entirety. In addition, please reference US patent publication number ”US2020244673A1, filed Apr. 23, 2019, titled “Multivariate network structure anomaly detector,” which is incorporated by reference in its entirety, for another example anomalous behavior detector with a Multivariate Network and Artificial Intelligence classifiers.

Next, as discussed further below, as discussed further below, during pre-deployment the cyber threat analyst module 120 and the analyzer module 115 can use data analysis processes and cooperate with AI model(s) 160 trained on forming and investigating hypotheses on what are a possible set of cyber threats. In addition, another set of AI models can be trained on how to form and investigate hypotheses on steps to take in supporting or refuting hypotheses. The AI models trained on forming and investigating hypotheses are updated with unsupervised machine learning algorithms when correctly supporting or refuting the hypotheses including what additional collected data proved to be the most useful.

### Additional Module Interactions

Referring back to FIG. 4, the gather module 110 cooperates with the data store 135. The data store 135 stores comprehensive logs for network traffic observed, email activity, cloud activity, etc. each domain can store their long term data storage in the data store. These logs can be filtered with complex logical queries and each, for example, IP packet can be interrogated on a vast number of metrics in the network information stored in the data store. The gather module 110 pulls data relevant for each possible hypothesis from the data store as well as from additional external and internal sources. In an example, the data store 135 can store the metrics and previous threat alerts associated with network traffic for a period of time, which is, by default, at least 27 days. This corpus of data is fully searchable. The cyber security appliance 100 works with network probes to monitor network traffic and store and record the data and metadata associated with the network traffic in the data store.

The gather module 110 may have a process identifier classifier. The process identifier classifier can identify and track each process and device in the network, under analysis, making communication connections. The data store 135 cooperates with the process identifier classifier to collect and maintain historical data of processes and their connections, which is updated over time as the network is in operation. In an example, the process identifier classifier can identify each process running on a given device along with its endpoint connections, which are stored in the data store. Similarly, data from any of the domains under analysis may be collected and compared. Examples of domains/networks under analysis being protected can include any of i) an Informational Technology network, ii) an Operational Technology network, iii) a Cloud service, iv) a SaaS service, v) an endpoint device, vi) an email domain, and vii) any combinations of these.

A domain module is constructed and coded to interact with and understand a specific domain. For instance, the IT network domain module 145 may receive information from and send information to, in this example, IT network-based sensors (i.e., probes, taps, etc.). The IT network domain module 145 also has algorithms and components configured to understand, in this example, IT network parameters, IT network protocols, IT network activity, and other IT network characteristics of the network under analysis. The second domain module 150 is, in this example, a cloud module 150. Another domain module may be an email module. The email domain module can receive information from and send information to, in this example, email-based sensors (i.e., probes, taps, etc.). The email domain module also has algorithms and components configured to understand, in this example, email parameters, email protocols and formats, email activity, and other email characteristics of the network under analysis. Additional domain modules, such as a cloud domain module can also collect domain data from another respective domain.

The coordinator module 155 is configured to work with various machine learning algorithms and relational mechanisms to i) assess, ii) annotate, and/or iii) position in a vector diagram, a directed graph, a relational database, etc., activity including events occurring, for example, in the first domain compared to activity including events occurring in the second domain. The domain modules can cooperate to exchange and store their information with the data store.

As discussed, the process identifier classifier in the gather module 110 can cooperate with additional classifiers in each of the domain modules 145/150 to assist in tracking individual processes and associating them with entities in a domain under analysis as well as individual processes and how they relate to each other. The process identifier classifier can cooperate with other trained AI classifiers in the modules to supply useful metadata along with helping to make logical nexuses. A feedback loop of cooperation exists between the gather module 110, the analyzer module 115, the domain specific modules such as the IT network module and/or email module, the AI model(s) 160 trained on different aspects of this process, and the cyber threat analyst module 120 to gather information to determine whether a cyber threat is potentially attacking the networks/domains under analysis.

### Determination of Whether Something is Likely Malicious

In the following examples the analyzer module 115 and/or cyber threat analyst module 120 can use multiple factors to the determination of whether a process, event, object, entity, etc. is likely malicious.

In an example, the analyzer module 115 and/or cyber threat analyst module 120 can cooperate with one or more of the AI model(s) 160 trained on certain cyber threats to detect whether the anomalous activity detected, such as suspicious email messages, exhibit traits that may suggest a malicious intent, such as phishing links, scam language, sent from suspicious domains, etc. The analyzer module 115 and/or cyber threat analyst module 120 can also cooperate with one of more of the AI model(s) 160 trained on potential IT based cyber threats to detect whether the anomalous activity detected, such as suspicious IT links, URLs, domains, user activity, etc., may suggest a malicious intent as indicated by the AI models trained on potential IT based cyber threats.

In the above example, the analyzer module 115 and/or the cyber threat analyst module 120 can cooperate with the one or more AI models 160 trained with machine learning on the normal pattern of life for entities in an email domain under analysis to detect, in this example, anomalous emails which are detected as outside of the usual pattern of life for each entity, such as a user, email server, etc., of the email network/domain. Likewise, the analyzer module 115 and/or the cyber threat analyst module 120 can cooperate with the one or more AI models trained with machine learning on the normal pattern of life for entities in a second domain under analysis (in this example, an IT network) to detect, in this example, anomalous network activity by user and/or devices in the network, which is detected as outside of the usual pattern of life (e.g. abnormal) for each entity, such as a user or a device, of the second domain's network under analysis.

Thus, the analyzer module 115 and/or the cyber threat analyst module 120 can be configured with one or more data analysis processes to cooperate with the one or more of the AI model(s) 160 trained with machine learning on the normal pattern of life in the system, to identify an anomaly of at least one of i) the abnormal behavior, ii) the suspicious activity, and iii) the combination of both, from one or more entities in the system. Note, other sources, such as other model breaches, can also identify at least one of i) the abnormal behavior, ii) the suspicious activity, and iii) the combination of both to trigger the investigation.

Accordingly, during this cyber threat determination process, the analyzer module 115 and/or the cyber threat analyst module 120 can also use AI classifiers that look at the features and determine a potential maliciousness based on commonality or overlap with known characteristics of malicious processes/entities. Many factors, including anomalies that include unusual and suspicious behavior, and other indicators of processes and events, are examined by the one or more AI models 160 trained on potential cyber threats including some supporting AI classifiers looking at specific features for their malicious nature in order to make a determination of whether an individual factor and/or whether a chain of anomalies is determined to be likely malicious.

Initially, in this example of activity in an IT network analysis, the rare JA3 hash and/or rare user agent connections for this network coming from a new or unusual process are factored just like in the first wireless domain suspicious wireless signals are considered. These are quickly determined by referencing the one or more of the AI model(s) 160 trained with machine learning on the pattern of life of each device and its associated processes in the system. Next, the analyzer module 115 and/or the cyber threat analyst module 120 can have an external input to ingest threat intelligence from other devices in the network cooperating with the cyber security appliance 100. Next, the analyzer module 115 and/or the cyber threat analyst module 120 can look for other anomalies, such as model breaches, while the AI models trained on potential cyber threats can assist in examining and factoring other anomalies that have occurred over a given timeframe to see if a correlation exists between a series of two or more anomalies occurring within that time frame.

The analyzer module 115 and/or the cyber threat analyst module 120 can combine these Indicators of Compromise (e.g., unusual network JA3, unusual device JA3, . . . ) with many other weak indicators to detect the earliest signs of an emerging threat, including previously unknown threats, without using strict blacklists or hard-coded thresholds. However, the AI classifiers can also routinely look at blacklists, etc. to identify maliciousness of features looked at. A deeper analysis may assist in confirming an analysis to determine that indeed a cyber threat has been detected. The analyzer module 115 can also look at factors of how rare the endpoint connection is, how old the endpoint is, where geographically the endpoint is located, how a security certificate associated with a communication is verified only by an endpoint device or by an external 3rd party, just to name a few additional factors. The analyzer module 115 (and similarly the cyber threat analyst module 120) can then assign weighting given to these factors in the machine learning that can be supervised based on how strongly that characteristic has been found to match up to actual malicious cyber threats learned in the training.

In another example, an AI classifier supporting the AI models 160 is trained to find potentially malicious indicators. The agent analyzer data analysis process in the analyzer module 115 and/or cyber threat analyst module 120 may cooperate with the process identifier classifier to identify all of the additional factors of i) are one or more processes running independently of other processes, ii) are the one or more processes running independent are recent to this network, and iii) are the one or more processes running independent connect to the endpoint, which the endpoint is a rare connection for this network, which are referenced and compared to one or more AI models 160 trained with machine learning on the normal behavior of the pattern of life of the system.

The analyzer module 115 and/or the cyber threat analyst module 120 may use the agent analyzer data analysis process that detects a potentially malicious agent previously unknown to the system to start an investigation on one or more possible cyber threat hypotheses. The determination and output of this step is what are possible cyber threats that can include or be indicated by the identified abnormal behavior and/or identified suspicious activity identified by the agent analyzer data analysis process.

In an example, the cyber threat analyst module 120 can use the agent analyzer data analysis process and the AI models(s) trained on forming and investigating hypotheses on what are a possible set of cyber threats to use the machine learning and/or set scripts to aid in forming one or more hypotheses to support or refute each hypothesis. The cyber threat analyst module 120 can cooperate with the AI models trained on forming and investigating hypotheses to form an initial set of possible hypotheses, which needs to be intelligently filtered down. The cyber threat analyst module 120 can be configured to use the one or more supervised machine learning models trained on i) agnostic examples of a past history of detection of a multitude of possible types of cyber threat hypotheses previously analyzed by human, who was a cyber security professional, ii) a behavior and input of how a plurality of human cyber security analysts make a decision and analyze a risk level regarding and a probability of a potential cyber threat, iii) steps to take to conduct an investigation start with anomaly via learning how expert humans tackle investigations into specific real and synthesized cyber threats and then the steps taken by the human cyber security professional to narrow down and identify a potential cyber threat, and iv) what type of data and metrics that were helpful to further support or refute each of the types of cyber threats, in order to determine a likelihood of whether the abnormal behavior and/or suspicious activity is either i) malicious or ii) benign?

The cyber threat analyst module 120 using AI models, scripts and/or rules based modules is configured to conduct initial investigations regarding the anomaly of interest, collected additional information to form a chain of potentially related/linked information under analysis and then form one or more hypotheses that could have this chain of information that is potentially related/linked under analysis and then gather additional information in order to refute or support each of the one or more hypotheses.

The cyber threat analyst module using AI models, scripts and/or rules-based modules is configured to conduct initial investigations regarding the anomaly of interest, collected additional information to form a chain of potentially related/linked information under analysis and then form one or more hypotheses that could have this chain of information that is potentially related/linked under analysis and then gather additional information in order to refute or support each of the one or more hypotheses.

In an example, a behavioural pattern analysis of what are the unusual behaviours of the network/system/device/user under analysis by the machine learning models may be as follows. The coordinator module can tie the alerts, activities, and events from, in this example, the email domain to the alerts, activities, and events from the IT network domain. FIG. 3 illustrates a graph 220 of an embodiment of an example chain of unusual behaviour for, in this example, the email activities and IT network activities deviating from a normal pattern of life in connection with the rest of the system/network under analysis. The cyber threat analyst module and/or analyzer module can cooperate with one or more machine learning models. The one or more machine learning models are trained and otherwise configured with mathematical algorithms to infer, for the cyber-threat analysis, ‘what is possibly happening with the chain of distinct alerts, activities, and/or events, which came from the unusual pattern,’ and then assign a threat risk associated with that distinct item of the chain of alerts and/or events forming the unusual pattern. The unusual pattern can be determined by examining initially what activities/events/alerts that do not fall within the window of what is the normal pattern of life for that network/system/device/user under analysis can be analysed to determine whether that activity is unusual or suspicious. A chain of related activity that can include both unusual activity and activity within a pattern of normal life for that entity can be formed and checked against individual cyber threat hypothesis to determine whether that pattern is indicative of a behaviour of a malicious actor—human, program, or other threat. The cyber threat analyst module can go back and pull in some of the normal activities to help support or refute a possible hypothesis of whether that pattern is indicative of a behavior of a malicious actor. An example behavioral pattern included in the chain is shown in the graph over a time frame of, an example, 7 days. The cyber threat analyst module detects a chain of anomalous behavior of unusual data transfers three times, unusual characteristics in emails in the monitored system three times which seem to have some causal link to the unusual data transfers. Likewise, twice unusual credentials attempted the unusual behavior of trying to gain access to sensitive areas or malicious IP addresses and the user associated with the unusual credentials trying unusual behavior has a causal link to at least one of those three emails with unusual characteristics. Again, the cyber security appliance 100 can go back and pull in some of the normal activities to help support or refute a possible hypothesis of whether that pattern is indicative of a behaviour of a malicious actor. The analyser module can cooperate with one or more models trained on cyber threats and their behaviour to try to determine if a potential cyber threat is causing these unusual behaviours. The cyber threat analyst module can put data and entities into 1) a directed graph and nodes in that graph that are overlapping or close in distance have a good possibility of being related in some manner, 2) a vector diagram, 3) a relational database, and 4) other relational techniques that will at least be examined to assist in creating the chain of related activity connected by causal links, such as similar time, similar entity and/or type of entity involved, similar activity, etc., under analysis. If the pattern of behaviours under analysis is believed to be indicative of a malicious actor, then a score of how confident is the system in this assessment of identifying whether the unusual pattern was caused by a malicious actor is created. Next, also assigned is a threat level score or probability indicative of what level of threat does this malicious actor pose. Lastly, the cyber security appliance 100 is configurable in a user interface, by a user, enabling what type of automatic response actions, if any, the cyber security appliance 100 may take when different types of cyber threats, indicated by the pattern of behaviours under analysis, that are equal to or above a configurable level of threat posed by this malicious actor. The chain of the individual alerts, activities, and events that form the pattern including one or more unusual or suspicious activities into a distinct item for cyber-threat analysis of that chain of distinct alerts, activities, and/or events. The cyber-threat module may reference the one or more machine learning models trained on, in this example, e-mail threats to identify similar characteristics from the individual alerts and/or events forming the distinct item made up of the chain of alerts and/or events forming the unusual pattern.

The autonomous response module 140 of the cyber security system is configured to take one or more autonomous mitigation actions to mitigate the cyber threat during the cyberattack by the cyber threat. The autonomous response module 140 is configured to reference an Artificial Intelligence model trained to track a normal pattern of life for each node of the protected system to perform an autonomous act of restricting a potentially compromised node having i) an actual indication of compromise and/or ii) merely adjacent to a known compromised node, to merely take actions that are within that node's normal pattern of life to mitigate the cyber threat. Similarly named components in the cyber security restoration engine 190 can operate and function similar to as described for the detection engine.

An Assessment of the Cyber Threat in Order to Determine Appropriate Autonomous Actions, for Example, those by the Autonomous Response Module

In the next step, the analyzer module 115 and/or cyber threat analyst module 120 generates one or more supported possible cyber threat hypotheses from the possible set of cyber threat hypotheses. The analyzer module generates the supporting data and details of why each individual hypothesis is supported or not. The analyzer module can also generate one or more possible cyber threat hypotheses and the supporting data and details of why they were refuted.

In general, the analyzer module 115 cooperates with the following three sources. The analyzer module 115 cooperates with the AI models trained on cyber threats to determine whether an anomaly such as the abnormal behavior and/or suspicious activity is either 1) malicious or 2) benign when the potential cyber threat under analysis is previously unknown to the cyber security appliance 100. The analyzer module cooperates with the AI models trained on a normal behavior of entities in the network under analysis. The analyzer module cooperates with various AI-trained classifiers. With all of these sources, when they input information that indicates a potential cyber threat that is i) severe enough to cause real harm to the network under analysis and/or ii) a close match to known cyber threats, then the analyzer module can make a final determination to confirm that a cyber threat likely exists and send that cyber threat to the assessment module to assess the threat score associated with that cyber threat. Certain model breaches will always trigger a potential cyber threat that the analyzer will compare and confirm the cyber threat.

In the next step, an assessment module with the AI classifiers is configured to cooperate with the analyzer module. The analyzer module supplies the identity of the supported possible cyber threat hypotheses from the possible set of cyber threat hypotheses to the assessment module. The assessment module with the AI classifiers cooperates with the AI model trained on possible cyber threats can make a determination on whether a cyber threat exists and what level of severity is associated with that cyber threat. The assessment module with the AI classifiers cooperates with the one or more AI models trained on possible cyber threats in order to assign a numerical assessment of a given cyber threat hypothesis that was found likely to be supported by the analyzer module with the one or more data analysis processes, via the abnormal behavior, the suspicious activity, or the collection of system data points. The assessment module with the AI classifiers output can be a score (ranked number system, probability, etc.) that a given identified process is likely a malicious process.

The assessment module with the AI classifiers can be configured to assign a numerical assessment, such as a probability, of a given cyber threat hypothesis that is supported and a threat level posed by that cyber threat hypothesis which was found likely to be supported by the analyzer module, which includes the abnormal behavior or suspicious activity as well as one or more of the collection of system data points, with the one or more AI models trained on possible cyber threats.

The cyber threat analyst module 120 in the AI-based cyber security appliance 100 component provides an advantage over competitors' products as it reduces the time taken for cybersecurity investigations, provides an alternative to manpower for small organizations and improves detection (and remediation) capabilities within the cyber security platform.

The AI-based cyber threat analyst module 120 performs its own computation of threat and identifies interesting network events with one or more processers. These methods of detection and identification of threat all add to the above capabilities that make the AI-based cyber threat analyst module a desirable part of the cyber security appliance 100. The AI-based cyber threat analyst module 120 offers a method of prioritizing which is not just a summary or highest score alert of an event evaluated by itself equals the most bad, and prevents more complex attacks being missed because their composite parts/individual threats only produced low-level alerts.

The AI classifiers can be part of the assessment component, which scores the outputs of the analyzer module. Again, as for the other AI classifiers discussed, the AI classifier can be coded to take in multiple pieces of information about an entity, object, and/or thing and based on its training and then output a prediction about the entity, object, or thing. Given one or more inputs, the AI classifier model will try to predict the value of one or more outcomes. The AI classifiers cooperate with the range of data analysis processes that produce features for the AI classifiers. The various techniques cooperating here allow anomaly detection and assessment of a cyber threat level posed by a given anomaly; but more importantly, an overall cyber threat level posed by a series/chain of correlated anomalies under analysis.

In the next step, the formatting module can generate an output such as a printed or electronic report with the relevant data. The formatting module can cooperate with both the analyzer module, the cyber threat analyst module, and the assessment module depending on what the user wants to be reported.

The formatting module is configured to format, present a rank for, and output one or more detected cyber threats from the analyzer module or from the assessment module into a formalized report, from one or more report templates populated with the data for that incident. Many different types of formalized report templates exist to be populated with data and can be outputted in an easily understandable format for a human user's consumption.

The formalized report on the template is outputted for a human user's consumption in a medium of any of 1) printable report, 2) presented digitally on a user interface, 3) in a machine readable format for further use in machine-learning reinforcement and refinement, or 4) any combination of the three. The formatting module is further configured to generate a textual write up of an incident report in the formalized report for a wide range of breaches of normal behavior, used by the AI models trained with machine learning on the normal behavior of the system, based on analyzing previous reports with one or more models trained with machine learning on assessing and populating relevant data into the incident report corresponding to each possible cyber threat. The formatting module can generate a threat incident report in the formalized report from a multitude of a dynamic human-supplied and/or machine created templates corresponding to different types of cyber threats, each template corresponding to different types of cyber threats that vary in format, style, and standard fields in the multitude of templates. The formatting module can populate a given template with relevant data, graphs, or other information as appropriate in various specified fields, along with a ranking of a likelihood of whether that hypothesis cyber threat is supported and its threat severity level for each of the supported cyber threat hypotheses, and then output the formatted threat incident report with the ranking of each supported cyber threat hypothesis, which is presented digitally on the user interface and/or printed as the printable report.

In the next step, the assessment module with the AI classifiers, once armed with the knowledge that malicious activity is likely occurring/is associated with a given process from the analyzer module, then cooperates with the autonomous response module 140 to take an autonomous action such as i) deny access in or out of the device or the network and/or ii) shutdown activities involving a detected malicious agent.

The autonomous response module 140, rather than a human taking an action, can be configured to cause one or more rapid autonomous mitigation actions to be taken to counter the cyber threat. A user interface for the response engine can program the autonomous response module 140 i) to merely make a suggested response to take to counter the cyber threat that will be presented on a display screen and/or sent by a notice to an administrator for explicit authorization when the cyber threat is detected or ii) to autonomously take a response to counter the cyber threat without a need for a human to approve the response when the cyber threat is detected. The autonomous response module 140 will then send a notice of the autonomous response as well as display the autonomous response taken on the display screen. Example autonomous responses may include cut off connections, shutdown devices, change the privileges of users, delete and remove malicious links in emails, slow down a transfer rate, Remove VM permissions, Modify networking rules, Modify IAM user or role policies, and other autonomous actions against the devices and/or users. The autonomous response module 140 uses one or more Artificial Intelligence models that are configured to intelligently work with other third-party defense systems in that customer's network against threats. The autonomous response module 140 can send its own protocol commands to devices and/or take actions on its own. In addition, the autonomous response module 140 uses the one or more Artificial Intelligence models to orchestrate with other third-party defense systems to create a unified defense response against a detected threat within or external to that customer's network. The autonomous response module 140 can be an autonomous self-learning response coordinator that is trained specifically to control and reconfigure the actions of traditional legacy computer defenses (e.g., firewalls, switches, proxy servers, etc.) to contain threats propagated by, or enabled by, networks and the internet. The cyber threat module can cooperate with the autonomous response module 140 to cause one or more autonomous actions in response to be taken to counter the cyber threat, improves computing devices in the system by limiting an impact of the cyber threat from consuming unauthorized CPU cycles, memory space, and power consumption in the computing devices via responding to the cyber threat without waiting for some human intervention.

The trigger module, analyzer module, assessment module, and formatting module cooperate to improve the analysis and formalized report generation with less repetition to consume CPU cycles with greater efficiency than humans repetitively going through these steps and re-duplicating steps to filter and rank the one or more supported possible cyber threat hypotheses from the possible set of cyber threat hypotheses.

The autonomous response module 140 is configured to use one or more Application Programming Interfaces to translate desired mitigation actions for nodes (devices, user accounts, etc.) into a specific language and syntax utilized by that device, user account, etc. from potentially multiple different vendors being protected in order to send the commands and other information to cause the desired mitigation actions to change, for example, a behavior of a detected threat of a user and/or a device acting abnormal to the normal pattern of life. The selected mitigation actions on the selected nodes minimize an impact on other parts of the system being protected (e.g., devices and users) that are i) currently active in the system being protected and ii) that are not in breach of being outside the normal behavior benchmark. The autonomous response module 140 can have a discovery module to i) discover capabilities of each node being protected device and the other cyber security devices (e.g., firewalls) in the system being protected and ii) discover mitigation actions they can take to counter and/or contain the detected threat to the system being protected, as well as iii) discover the communications needed to initiate those mitigation actions.

For example, the autonomous response module 140 cooperates and coordinates with an example set of network capabilities of various network devices. The network devices may have various capabilities such as identity management including setting user permissions, network security controls, firewalls denying or granting access to various ports, encryption capabilities, centralize logging, antivirus anti-malware software quarantine and immunization, patch management, etc., and also freeze any similar, for example, network activity, etc. triggering the harmful activity on the system being protected.

Accordingly, the autonomous response module 140 will take an autonomous mitigation action to, for example, shutdown the device or user account, block login failures, perform file modifications, block network connections, restrict the transmission of certain types of data, restrict a data transmission rate, remove or restrict user permissions, etc. The autonomous response module 140 for an email system could initiate example mitigation actions to either remedy or neutralize the tracking link, when determined to be the suspicious covert tracking link, while not stopping every email entering the email domain with a tracking link, or hold the email communication entirely if the covert tracking link is highly suspicious, and also freeze any similar, for example, email activity triggering the harmful activity on the system being protected.

The autonomous response module 140 has a default set of autonomous mitigation actions shown on its user interface that it knows how to perform when the different types of cyber threats are equal to or above a user configurable threshold posed by this type of cyber threat. The autonomous response module 140 is also configurable in its user interface to allow the user to augment and change what type of automatic mitigation actions, if any, the autonomous response module 140 may take when different types of cyber threats that are equal to or above the configurable level of threat posed by a cyber threat.

Referring to FIG. 2, the cyber-attack simulator 105 using Artificial Intelligence-based simulations is communicatively coupled to a cyber security appliance 100, the forensic acquisition and investigation service 301, an open source (OS) database server 790, an email system 796, one or more endpoint computing devices 791A-B, and an IT network system 792 with one or more entities, over one or more networks 746/747 in the system being protected.

The cyber-attack simulator 105 with Artificial Intelligence-based simulations is configured to integrate with the cyber security appliance 100 and cooperate with components within the cyber security appliance 100 installed and protecting the network from cyber threats by making use of outputs, data collected, and functionality from two or more of a data store, other modules, and one or more AI models already existing in the cyber security appliance 100.

The cyber-attack simulator 105 may include a cyber threat generator module to generate many different types of cyber threats with the past historical attack patterns to attack the simulated system to be generated by the simulated attack module 750 that will digitally/virtually replicate the system being protected, such as a phishing email generator configured to generate one or more automated phishing emails to pentest the email defenses and/or the network defenses provided by the cyber security appliance 100. For example, the system being protected can be an email system and then the phishing email generator may be configured to cooperate with the trained AI models to customize the automated phishing emails based on the identified data points of the organization and its entities.

The email module, the cloud module, and IT network module may use a vulnerability tracking module to track and profile, for example, versions of software and a state of patches and/or updates compared to a latest patch and/or update of the software resident on devices in the system/network. The vulnerability tracking module can supply results of the comparison of the version of software as an actual detected vulnerability for each particular node in the system being protected, which is utilized by the node exposure score generator and the cyber-attack simulator 105 with Artificial Intelligence-based simulations in calculating 1) the spread of a cyber threat and 2) a prioritization of remediation actions on a particular node compared to the other network nodes with actual detected vulnerabilities. The node exposure score generator is configured to also factor in whether the particular node is exposed to direct contact by an entity generating the cyber threat (when the threat is controlled from a location external to the system e.g., network) or the particular node is downstream of a node exposed to direct contact by the entity generating the cyber threat external to the network.

The node exposure score generator and the simulated attack module 750 in the cyber-attack simulator 105 cooperate to run the one or more hypothetical simulations of an actual detected cyber threat incident and/or a hypothetical cyberattack incident to calculate the node paths of least resistance in the virtualized instance/modeled instance of the system being protected. The progress through the node path(s) of least resistance through the system being protected are plotted through the various simulated instances of components of the graph of the system being protected until reaching a suspected end goal of the cyber-attack scenario, all based on historic knowledge of connectivity and behavior patterns of users and devices within the system under analysis. See for example FIGS. 7A and 7B. The simulated attack module 750, via a simulator and/or a virtual network clone creator, can be programmed to model and work out the key paths and devices in the system (e.g., a network, with its nets and subnets,) via initially mapping out the system being protected and querying the cyber security appliance on specific's known about the system being protected by the cyber security appliance 100. The simulated attack module 750 is configured to search and query, two or more of i) a data store, ii) modules in the detection engine, and iii) the one or more Artificial Intelligence (AI) models making up the cyber security appliance 100 protecting the actual network under analysis from cyber threats, on what, i) the data store, ii) the modules, and iii) the one or more AI models in the cyber security appliance 100, already know about the nodes of the system, under analysis to create the graph of nodes of the system being protected. Thus, the cyber-attack simulator 105 with Artificial Intelligence-based simulations is configured to construct the graph of the virtualized version of the system from knowledge known and stored by modules, a data store, and one or more AI models of a cyber security appliance 100 protecting an actual network under analysis. The knowledge known and stored is obtained at least from ingested traffic from the actual system under analysis. Thus, the virtualized system, and its node components/accounts connecting to the network, being tested during the simulation are up to date and accurate for the time the actual system under analysis is being tested and simulated because the cyber-attack simulator 105 with Artificial Intelligence-based simulations is configured to obtain actual network data collected by two or more of 1) modules, 2) a data store, and 3) one or more AI models of a cyber security appliance protecting the actual network under analysis from cyber threats. The simulated attack module 750 will make a model incorporating the actual data of the system through the simulated versions of the nodes making up that system for running simulations on the simulator. Again, a similar approach is taken when the simulated attack module 750 uses a clone creator to spin up and create a virtual clone of the system being protected with virtual machines in the cloud.

The cyber-attack simulator 105 with Artificial Intelligence-based simulations is configured to simulate the compromise of a spread of the cyber threat being simulated in the simulated cyber-attack scenario, based on historical and/or similar cyber threat attack patterns, between the devices connected to the virtualized network, via a calculation on an ease of transmission of the cyber threat algorithm, from 1) an originally compromised node by the cyber threat, 2) through to other virtualized/ simulated instances of components of the virtualized network, 3) until reaching a suspected end goal of the cyber-attack scenario, including key network devices. The cyber-attack simulator 105 with Artificial Intelligence-based simulations also calculates how likely it would be for the cyber-attack to spread to achieve either of 1) a programmable end goal of that cyber-attack scenario set by a user, or 2) set by default an end goal scripted into the selected cyber-attack scenario.

The email module, the cloud module, and the IT network module can include a profile manager module. The profile manager module is configured to maintain a profile tag on all of the devices connecting to the actual system/network under analysis based on their behavior and security characteristics and then supply the profile tag for the devices connecting to the virtualized instance of the system/network when the construction of the graph occurs. The profile manager module is configured to maintain a profile tag for each device before the simulation is carried out; and thus, eliminates a need to search and query for known data about each device being simulated during the simulation. This also assists in running multiple simulations of the cyberattack in parallel.

The cyber-attack simulator 105 with Artificial Intelligence-based simulations module is configured to construct the graph of the virtualized system, e.g. a network with its nets and subnets, where two or more of the devices connecting to the virtualized network are assigned with different weighting resistances to malicious compromise from the cyber-attack being simulated in the simulated cyber-attack scenario based on the actual cyber-attack on the virtualized instance of the network and their node vulnerability score. In addition to a weighting resistance to the cyberattack, the calculations in the model for the simulated attack module 750 factor in the knowledge of a layout and connection pattern of each particular network device in a network, an amount of connections and/or hops to other network devices in the network, how important a particular device (a key importance) determined by the function of that network device, the user(s) associated with that network device, and the location of the device within the network. Note, multiple simulations can be conducted in parallel by the orchestration module. The simulations can occur on a periodic regular basis to pentest the cyber security of the system and/or in response to a detected ongoing cyberattack in order to get ahead of the ongoing cyberattack and predict its likely future moves. Again, the graph of the virtualize instance of the system is created with two or more of 1) known characteristics of the network itself, 2) pathway connections between devices on that network, 3) security features and credentials of devices and/or their associated users, and 4) behavioral characteristics of the devices and/or their associated users connecting to that network, which all of this information is obtained from what was already know about the network from the cyber security appliance.

During an ongoing cyberattack, the simulated attack module 750 is configured to run the one or more hypothetical simulations of the detected cyber threat incident and feed details of a detected incident by a cyber threat module in the detection engine into the collections module of the cyber-attack simulator 105 using Artificial Intelligence-based simulations. The simulated attack module 750 is configured to run one or more hypothetical simulations of that detected incident in order to predict and assist in the triggering an autonomous response by the autonomous response module 140 and then restoration by the restoration engine to the detected incident.

The simulated attack module 750 ingests the information for the purposes of modeling and simulating a potential cyberattacks against the network and routes that an attacker would take through the network. The simulated attack module 750 can construct the graph of nodes with information to i) understand an importance of network nodes in the network compared to other network nodes in the network, and ii) to determine key pathways within the network and vulnerable network nodes in the network that a cyber-attack would use during the cyber-attack, via modeling the cyber-attack on at least one of 1) a simulated device version and 2) a virtual device version of the system being protected under analysis. Correspondingly, the calculated likelihood of the compromise and timeframes for the spread of the cyberattack is tailored and accurate to each actual device/user account (e.g., node) being simulated in the system because the cyber-attack scenario is based upon security credentials and behavior characteristics from actual traffic data fed to the modules, data store, and AI models of the cyber security appliance.

The cyber-attack simulator 105 with its Artificial Intelligence trained on how to conduct and perform cyberattack in a simulation in either a simulator or in a clone creator spinning up virtual instances on virtual machines will take a sequence of actions and then evaluate the actual impact after each action in the sequence, in order to yield a best possible result to contain/mitigate the detected threat while minimizing the impact on other network devices and users that are i) currently active and ii) not in breach, from different possible actions to take. Again, multiple simulations can be run in parallel so that the different sequences of mitigation actions and restoration actions can be evaluated essentially simultaneously. The cyber-attack simulator 105 with Artificial Intelligence-based simulations in the cyber-attack simulator 105 is configured to use one or more mathematical functions to generate a score and/or likelihood for each of the possible actions and/or sequence of multiple possible actions that can be taken in order to determine which set of actions to choose among many possible actions to initiate. The one or more possible actions to take and their calculated scores can be stacked against each other to factor 1) a likelihood of containing the detected threat acting abnormal with each possible set of actions, 2) a severity level of the detected threat to the network, and 3) the impact of taking each possible set of actions i) on users and ii) on devices currently active in the network not acting abnormal to the normal behavior of the network, and then communicate with the cyber threat detection engine, the autonomous response module 140, and the cyber-security restoration engine 190, respectively, to initiate the chosen set of actions to cause a best targeted change of the behavior of the detected threat acting abnormal to the normal pattern of life on the network while minimizing the impact on other network devices and users that are i) currently active and ii) not in breach of being outside the normal behavior benchmark. The cyber-attack simulator cooperates with the AI models modelling a normal pattern of life for entities/nodes in the system being protected.

The simulated attack module 750 is programmed itself and can cooperate with the artificial intelligence in the restoration engine to factor an intelligent prioritization of remediation actions and which nodes (e.g., devices and user accounts) in the simulated instance of the system being protected should have a priority compared to other nodes. This can also be reported out to assist in allocating human security team personnel resources that need human or human approval to restore the nodes based on results of the one or more hypothetical simulations of the detected incident.

Note, the cyberattack simulator 105, when doing attack path modelling, does not need to not calculate every theoretically possible path from the virtualized instance of the source device to the end goal of the cyber-attack scenario but rather a set of the most likely paths, each time a hop is made from one node in the virtualized network to another device in the virtualized network, in order to reduce an amount of computing cycles needed by the one or more processing units as well as an amount of memory storage needed in the one or more non-transitory storage mediums.

FIG. 8 illustrates a block diagram of an embodiment of the AI-based cyber security appliance 100 with the forensic acquisition and investigation service 203 and other Artificial Intelligence-based engines plugging in as an appliance platform to protect a system. The probes and detectors monitor, in this example, email activity and IT network activity to feed this data to determine what is occurring in each domain individually to their respective modules configured and trained to understand that domain's information as well as correlate causal links between these activities in these domains to supply this input into the modules of the cyber security appliance 100. The network can include various computing devices such as desktop units, laptop units, smart phones, firewalls, network switches, routers, servers, databases, Internet gateways, etc. The forensic acquisition and investigation service can be implemented on a cloud platform 301a or an appliance 301b plugged into the network.

Referring back to FIG. 4, a computer system within a building, can use the cyber security appliance 100 to detect and thereby attempt to prevent threats to computing devices within its bounds. In this exemplary embodiment of the cyber security appliance 100 with the multiple Artificial Intelligence-based engines is implemented on a computer. The computer has the electronic hardware, modules, models, and various software processes of the cyber security appliance 100; and therefore, runs threat detection for detecting threats to the first computer system. As such, the computer system includes one or more processors arranged to run the steps of the process described herein, memory storage components required to store information related to the running of the process, as well as a network interface for collecting the required information for the probes and other sensors collecting data from the network under analysis.

The cyber security appliance 100 in the computer builds and maintains a dynamic, ever-changing model of the ‘normal behavior’ of each user and machine within the system. The approach is based on Bayesian mathematics, and monitors all interactions, events, and communications within the system-which computer is talking to which, files that have been created, networks that are being accessed.

For example, a second computer is-based in a company's San Francisco office and operated by a marketing employee who regularly accesses the marketing network, usually communicates with machines in the company's U.K. office in second computer system 40 between 9.30 AM and midday, and is active from about 8:30 AM until 6 PM.

The same employee virtually never accesses the employee time sheets, very rarely connects to the company's Atlanta network and has no dealings in South-East Asia. The security appliance takes all the information that is available relating to this employee and establishes a ‘pattern of life’ for that person and the devices used by that person in that system, which is dynamically updated as more information is gathered. The model of the normal pattern of life for an entity in the network under analysis is used as a moving benchmark, allowing the cyber security appliance 100 to spot behavior on a system that seems to fall outside of this normal pattern of life, and flags this behavior as anomalous, requiring further investigation and/or autonomous action.

The cyber security appliance 100 is built to deal with the fact that today's attackers are getting stealthier and an attacker/malicious agent may be ‘hiding’ in a system to ensure that they avoid raising suspicion in an end user, such as by slowing their machine down. The Artificial Intelligence model(s) in the cyber security appliance 100 builds a sophisticated ‘pattern of life’—that understands what represents normality for every person, device, and network activity in the system being protected by the cyber security appliance 100.

The self-learning algorithms in the AI can, for example, understand each node's (user account, device, etc.) in an organization's normal patterns of life in about a week, and grows more bespoke with every passing minute. Conventional AI typically relies solely on identifying threats based on historical attack data and reported techniques, requiring data to be cleansed, labelled, and moved to a centralized repository. The detection engine self-learning AI can learn “on the job” from real-world data occurring in the system and constantly evolves its understanding as the system's environment changes. The Artificial Intelligence can use machine learning algorithms to analyze patterns and ‘learn’ what is the ‘normal behavior’ of the network by analyzing data on the activity on the network at the device and employee level. The unsupervised machine learning does not need humans to supervise the learning in the model but rather discovers hidden patterns or data groupings without the need for human intervention. The unsupervised machine learning discovers the patterns and related information using the unlabeled data monitored in the system itself. Unsupervised learning algorithms can include clustering, anomaly detection, neural networks, etc. Unsupervised Learning can break down features of what it is analyzing (e.g., a network node of a device or user account), which can be useful for categorization, and then identify what else has similar or overlapping feature sets matching to what it is analyzing.

The cyber security appliance 100 can use unsupervised machine learning to works things out without pre-defined labels. In the case of sorting a series of different entities, such as animals, the system analyzes the information and works out the different classes of animals. This allows the system to handle the unexpected and embrace uncertainty when new entities and classes are examined. The modules and models of the cyber security appliance 100 do not always know what they are looking for, but can independently classify data and detect compelling patterns.

The cyber security appliance's 100 unsupervised machine learning methods do not require training data with pre-defined labels. Instead, they are able to identify key patterns and trends in the data, without the need for human input. The advantage of unsupervised learning in this system is that it allows computers to go beyond what their programmers already know and discover previously unknown relationships. The unsupervised machine learning methods can use a probabilistic approach based on a Bayesian framework. The machine learning allows the cyber security appliance 100 to integrate a huge number of weak indicators/low threat values by themselves of potentially anomalous network behavior to produce a single clear overall measure of these correlated anomalies to determine how likely a network device is to be compromised. This probabilistic mathematical approach provides an ability to understand important information, amid the noise of the network-even when it does not know what it is looking for.

The models in the cyber security appliance 100 can use a Recursive Bayesian Estimation to combine these multiple analyzers of different measures of network behavior to generate a single overall/comprehensive picture of the state of each device, the cyber security appliance 100 takes advantage of the power of Recursive Bayesian Estimation (RBE) via an implementation of the Bayes filter.

Using RBE, the cyber security appliance 100's AI models are able to constantly adapt themselves, in a computationally efficient manner, as new information becomes available to the system. The cyber security appliance 100's AI models continually recalculate threat levels in the light of new evidence, identifying changing attack behaviors where conventional signature-based methods fall down.

Training a model can be accomplished by having the model learn good values for all of the weights and the bias for labeled examples created by the system, and in this case, starting with no labels initially. A goal of the training of the model can be to find a set of weights and biases that have low loss, on average, across all examples.

The AI classifier can receive supervised machine learning with a labeled data set to learn to perform their task as discussed herein. An anomaly detection technique that can be used is supervised anomaly detection that requires a data set that has been labeled as “normal” and “abnormal” and involves training a classifier. Another anomaly detection technique that can be used is an unsupervised anomaly detection that detects anomalies in an unlabeled test data set under the assumption that the majority of the instances in the data set are normal, by looking for instances that seem to fit least to the remainder of the data set. The model representing normal behavior from a given normal training data set can detect anomalies by establishing the normal pattern and then test the likelihood of a test instance under analysis to be generated by the model. Anomaly detection can identify rare items, events or observations which raise suspicions by differing significantly from the majority of the data, which includes rare objects as well as things like unexpected bursts in activity.

The methods and systems shown in the Figures and discussed in the text herein can be coded to be performed, at least in part, by one or more processing components with any portions of software stored in an executable format on a computer readable medium. Thus, any portions of the method, apparatus and system implemented as software can be stored in one or more non-transitory storage devices in an executable format to be executed by one or more processors. The computer readable storage medium may be non-transitory and does not include radio or other carrier waves. The computer readable storage medium could be, for example, a physical computer readable storage medium such as semiconductor memory or solid-state memory, magnetic tape, a removable computer diskette, a random-access memory (RAM), a read-only memory (ROM), a rigid magnetic disc, and an optical disk, such as a CD-ROM, CD-R/W or DVD. The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

A computing system can be, wholly or partially, part of one or more of the server or client computing devices in accordance with some embodiments. Components of the computing system can include, but are not limited to, a processing unit having one or more processing cores, a system memory, and a system bus that couples various system components including the system memory to the processing unit.

### Computing Devices

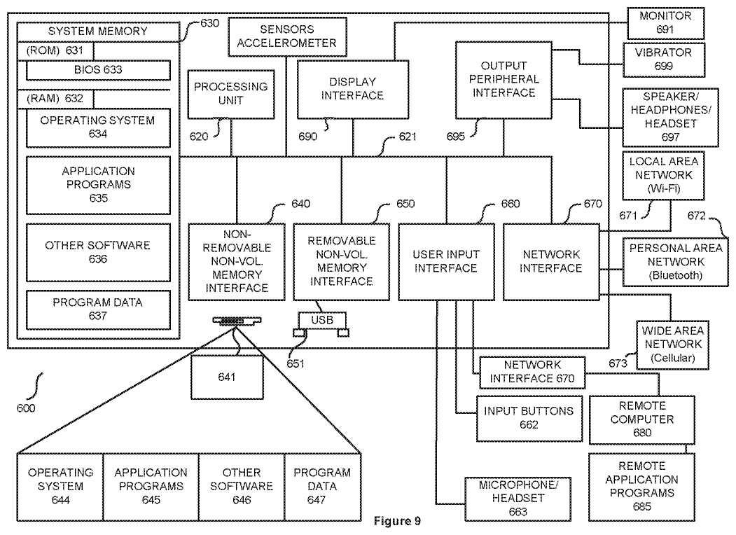

FIG. 9 illustrates a block diagram of an embodiment of one or more computing devices that can be a part of the Artificial Intelligence-based cyber security system including the multiple Artificial Intelligence-based engines and the forensic acquisition and investigation service 203 discussed herein.

The computing device may include one or more processors or processing units 620 to execute instructions, one or more memories 630-632 to store information, one or more data input components 660-663 to receive data input from a user of the computing device 600, one or more modules that include the management module, a network interface communication circuit 670 to establish a communication link to communicate with other computing devices external to the computing device, one or more sensors where an output from the sensors is used for sensing a specific triggering condition and then correspondingly generating one or more preprogrammed actions, a display screen 691 to display at least some of the information stored in the one or more memories 630-632 and other components. Note, portions of this design implemented in software 644, 645, 646 are stored in the one or more memories 630-632 and are executed by the one or more processors 620. The processing unit 620 may have one or more processing cores, which couples to a system bus 621 that couples various system components including the system memory 630. The system bus 621 may be any of several types of bus structures selected from a memory bus, an interconnect fabric, a peripheral bus, and a local bus using any of a variety of bus architectures.

Computing device 602 typically includes a variety of computing machine-readable media. Machine-readable media can be any available media that can be accessed by computing device 602 and includes both volatile and nonvolatile media, and removable and non-removable media. By way of example, and not limitation, computing machine-readable media use includes storage of information, such as computer-readable instructions, data structures, other executable software, or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, and which can be accessed by the computing device 602. Transitory media such as wireless channels are not included in the machine-readable media. Machine-readable media typically embody computer readable instructions, data structures, and other executable software. In an example, a volatile memory drive 641 is illustrated for storing portions of the operating system 644, application programs 645, other executable software 646, and program data 647.

A user may enter commands and information into the computing device 602 through input devices such as a keyboard, touchscreen, or software or hardware input buttons 662, a microphone 663, a pointing device and/or scrolling input component, such as a mouse, trackball, or touch pad 661. The microphone 663 can cooperate with speech recognition software. These and other input devices are often connected to the processing unit 620 through a user input interface 660 that is coupled to the system bus 621, but can be connected by other interface and bus structures, such as a lighting port, game port, or a universal serial bus (USB). A display monitor 691 or other type of display screen device is also connected to the system bus 621 via an interface, such as a display interface 690. In addition to the monitor 691, computing devices may also include other peripheral output devices such as speakers 697, a vibration device 699, and other output devices, which may be connected through an output peripheral interface 695.

The computing device 602 can operate in a networked environment using logical connections to one or more remote computers/client devices, such as a remote computing system 680. The remote computing system 680 can a personal computer, a mobile computing device, a server, a router, a network PC, a peer device, or other common network node, and typically includes many or all of the elements described above relative to the computing device 602. The logical connections can include a personal area network (PAN) 672 (e.g., Bluetooth®), a local area network (LAN) 671 (e.g., Wi-Fi), and a wide area network (WAN) 673 (e.g., cellular network). Such networking environments are commonplace in offices, enterprise-wide computer networks, intranets, and the Internet. A browser application and/or one or more local apps may be resident on the computing device and stored in the memory.

When used in a LAN networking environment, the computing device 602 is connected to the LAN 671 through a network interface 670, which can be, for example, a Bluetooth® or Wi-Fi adapter. When used in a WAN networking environment (e.g., Internet), the computing device 602 typically includes some means for establishing communications over the WAN 673. With respect to mobile telecommunication technologies, for example, a radio interface, which can be internal or external, can be connected to the system bus 621 via the network interface 670, or other appropriate mechanism. In a networked environment, other software depicted relative to the computing device 602, or portions thereof, may be stored in the remote memory storage device. By way of example, and not limitation, remote application programs 685 as reside on remote computing device 680. It will be appreciated that the network connections shown are examples and other means of establishing a communications link between the computing devices that may be used. It should be noted that the present design can be carried out on a single computing device or on a distributed system in which different portions of the present design are carried out on different parts of the distributed computing system.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A software engine is a core component of a complex system consisting of hardware and software that is capable of performing its function discretely from other portions of the entire complex system but designed to interact with the other portions of the entire complex system. The systems and methods described herein can be implemented with these algorithms discussed herein.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

1. A system, comprising:
a forensic acquisition and investigation service configured to receive a trigger signal, including any of i) an alert, ii) a model breach, and iii) a cyber threat investigation, from one or more parts of a cyber security system, to parse through information in the trigger signal to identify any components indicated in the trigger signal, to launch a forensic acquisition investigation on the components indicated in the trigger signal, to store one or more snapshots of information captured during the forensic acquisition investigation from the components, and then to cooperate with a user interface to present the trigger signal of i) the alert, ii) the model breach, and/or iii) the cyber threat investigation on the user interface as well as the information captured from the one or more snapshots from the forensic acquisition investigation on the user interface.

2. The system of claim 1, where the forensic acquisition and investigation service is configured to receive the trigger signal, including any of i) the alert, ii) the model breach, and/or iii) the cyber threat investigation, from the one or more parts of the cyber security system, where the one or more parts of the cyber security system include a cyber-security restoration engine configured to restore components back to an operational state in response to a cyber attack, a cybersecurity appliance configured to detect a presence of a cyber threat, a cyber threat analyst module configured to perform the cyber threat investigation, and a cyber-attack simulator to run simulations of the cyber attack by the cyber threat, where the trigger signal is configured to be communicated securely over a network to an application programming interface of the forensic acquisition and investigation service to trigger the launch of the forensic acquisition investigation on the components.

3. The system of claim 1, where the forensic acquisition and investigation service is configured to use a set of scripts to take the one or more snapshots in time of the information including operational state information, configuration settings, disk data, and ephemeral process data, in a manner with timestamps that maintains a full chain of custody for the forensic acquisition investigation on the components involved in the trigger signal.

4. The system of claim 1, where the forensic acquisition and investigation service is configured 1) to use a set of scripts to conduct the forensic acquisition investigation on the components, 2) to receive a forensic artifact of a snapshot of at least an operational state and disk data of the components from the forensic acquisition investigation, and then 3) to store information captured from the snapshot from the forensic acquisition investigation in a database.

5. The system of claim 1, where the user interface is configured with an interactive element that is scripted to allow a user to highlight and select any component, in an architecture being protected by the cyber security system, that is displayed on the user interface, and then to activate an investigate button to manually launch the forensic acquisition investigation on the selected component as well as another section to review the trigger signal of i) the alert, ii) the model breach, and/or iii) the cyber threat investigation on the user interface along with the information captured from the one or more snapshots from the forensic acquisition investigation on the user interface.

6. The system of claim 1, where the user interface is configured with a first tab scripted to pull in additional information on any analyst review of this incident, and a second tab to see a history of this component, including any previous investigations.

7. The system of claim 1, where a first part of the cyber security system is a cyber threat analyst module configured to perform the cyber threat investigation on a chain of two or more anomalous activities on the components being protected by the cyber security system, and when the cyber threat analyst module determines a certain level of anomaly equal to or above a threshold with the cyber threat investigation, then the cyber threat analyst module is configured to automatically generate the trigger signal to the forensic acquisition and investigation service to launch the forensic acquisition investigation.

8. The system of claim 1, where a first part of the cyber security system is a cyber-security restoration engine configured to restore components back to an operational state in response to a cyber attack, and where the cyber-security restoration engine is configured to automatically generate the trigger signal to the forensic acquisition and investigation service to launch the forensic acquisition investigation as an action from an incident readiness and recovery playbook.

9. The system of claim 1, where a first part of the cyber security system is a cyber-attack simulator configured to run simulations of a cyber attack by a cyber threat, and where the cyber-attack simulator is configured to automatically generate the trigger signal to the forensic acquisition and investigation service to launch the forensic acquisition investigation on components in a likely attack path.

10. The system of claim 1, where a first part of the cyber security system is an endpoint agent resident on an endpoint computing device, where the forensic acquisition and investigation service is configured to receive the trigger signal on at least one of a first alert or a first model breach involving the endpoint computing device with the endpoint agent resident, where the forensic acquisition and investigation service is configured to send a command to the endpoint agent on the endpoint computing device to invoke the endpoint agent to capture the information including at least an operational state and data on that endpoint computing device with time stamps of a point in time of the capture, and then to receive that information back over a network.

11. A method for a system, comprising:
configuring a forensic acquisition and investigation service to receive a trigger signal, including any of i) an alert, ii) a model breach, and iii) a cyber threat investigation, from one or more parts of a cyber security system, to parse through information in the trigger signal to identify any components indicated in the trigger signal, to launch a forensic acquisition investigation on the components indicated in the trigger signal, to store one or more snapshots of information captured during the forensic acquisition investigation from the components, and
configuring the forensic acquisition and investigation service to cooperate with a user interface to present the trigger signal of i) the alert, ii) the model breach, and/or iii) the cyber threat investigation on the user interface as well as the information captured from the one or more snapshots from the forensic acquisition investigation on the user interface.

12. The method for the system of claim 11, further comprising:
configuring the user interface to allow users to be able to tune parameters that determine what types and levels of alerts, model breaches, and cyber threat incidents will be automatically sent to an application programming interface of the forensic acquisition and investigation service to trigger the forensic acquisition investigation.

13. The method for the system of claim 11, further comprising:
configuring the forensic acquisition and investigation service to use a set of scripts to take the one or more snapshots in time of the information including operational state information, configuration settings, disk data, and ephemeral process data, in a manner with timestamps that maintains a full chain of custody for the forensic acquisition investigation on the components involved in the trigger signal.

14. The method for the system of claim 11, further comprising:
configuring the forensic acquisition and investigation service 1) to use a set of scripts to conduct the forensic acquisition investigation on the components, 2) to receive a forensic artifact of a snapshot of at least an operational state and disk data of the components from the forensic acquisition investigation, and then 3) to store information captured from the snapshot from the forensic acquisition investigation in a database.

15. The method for the system of claim 11, further comprising:
configuring the user interface with an interactive element that is scripted to allow a user to highlight and select any component, in an architecture being protected by the cyber security system, that is displayed on the user interface, and then to activate an investigate button to manually launch the forensic acquisition investigation on the selected component as well as another section to review the trigger signal of i) the alert, ii) the model breach, and/or iii) the cyber threat investigation on the user interface along with the information captured from the one or more snapshots from the forensic acquisition investigation on the user interface.

16. The method for the system of claim 11, further comprising:
configuring the user interface with a first tab scripted to pull in additional information on any analyst review of this incident, and a second tab to see a history of this component, including any previous investigations.

17. The method for the system of claim 11, further comprising:
configuring a first part of the cyber security system to be a cyber threat analyst module configured to perform the cyber threat investigation on a chain of two or more anomalous activities on the components being protected by the cyber security system, and
configuring when the cyber threat analyst module determines a certain level of anomaly equal to or above a threshold with the cyber threat investigation to then automatically generate the trigger signal to the forensic acquisition and investigation service to launch the forensic acquisition investigation.

18. The method for the system of claim 11, further comprising:
configuring a first part of the cyber security system to be a cyber-security restoration engine configured to restore components back to an operational state in response to a cyber attack, and
configuring the cyber-security restoration engine to automatically generate the trigger signal to the forensic acquisition and investigation service to launch the forensic acquisition investigation as an action from an incident readiness and recovery playbook.

19. The method for the system of claim 11, further comprising:
configuring a first part of the cyber security system to be a cyber-attack simulator configured to run simulations of a cyber attack by a cyber threat, and
configuring where the cyber-attack simulator to automatically generate the trigger signal to the forensic acquisition and investigation service to launch the forensic acquisition investigation on components in a likely attack path.

20. The method for the system of claim 11, further comprising:
configuring a first part of the cyber security system to be an endpoint agent resident on an endpoint computing device, and
configuring where the forensic acquisition and investigation service to receive the trigger signal on at least one of a first alert or a first model breach involving the endpoint computing device with the endpoint agent resident, where the forensic acquisition and investigation service is configured to send a command to the endpoint agent on the endpoint computing device to invoke the endpoint agent to capture the information including at least an operational state and data on that endpoint computing device with time stamps of a point in time of the capture, and then to receive that information back over a network.
